(19) United States
(12) Patent Application Publication
(10) Pub. No.: US 2026/0299203 A1
(43) Pub. Date: Oct. 1, 2026

(54) OPTICAL SYSTEM

(71) Applicant: SUMITOMO CHEMICAL COMPANY, LIMITED, Tokyo (JP)

(72) Inventors: Takuya MATSUURA, Osaka-shi (JP); Tomohiro FUKUURA, Osaka-shi (JP)

(73) Assignee: SUMITOMO CHEMICAL COMPANY, LIMITED, Tokyo (JP)

(21) Appl. No.: 18/996,586

(22) PCT Filed: Jul. 18, 2023
(86) PCT No.: PCT/JP2023/026257

§ 371 Date: Jan. 17, 2025

(30) Foreign Application Priority Data
Jul. 29, 2022 (JP) 2022-121727

(51) Int. Cl. G02B 6/26; G02B 6/34

(52) U.S. Cl. CPC G02B 6/262; G02B 6/34

(57) ABSTRACT

An optical system 101 includes a core 1A, a Si waveguide 2A having a light spot size different from that of the core 1A, and a metalens 3 optically connecting the core 1A and the Si waveguide 2A. The metalens has a first surface 31A facing the first waveguide and a second surface 31B facing a side opposite to the first surface. The metalens is provided with a through hole 31C penetrating between the first surface and the second surface. The through hole has a hole diameter smaller than a target wavelength. The metalens is made of a conductor. The first surface of the metalens is formed with a plurality of uneven structures including the first surface and a plurality of annular grooves 31D recessed with respect to the first surface. The plurality of uneven structures are annularly formed so as to surround the through hole in plan view.

### TECHNICAL FIELD

The present invention relates to an optical system, particularly to an optical system capable of connecting two optical waveguides having different sizes.

### BACKGROUND ART

WO 2018/105712 A (Patent Document 1) describes a polymer waveguide type spot size converter for connecting two optical waveguides having different sizes.

JP-A-2021-148851 (Patent Document 2) discloses a photoelectric fusion module including an optical integrated circuit including a plurality of waveguide cores and an optical path conversion unit for connecting each of the plurality of waveguide cores to a core of an optical fiber. The optical path conversion unit includes a spot size converter, a curved mirror, a plated mirror, and a polymer waveguide.

### PRIOR ART DOCUMENTS

### Patent Documents

Patent Document 1: WO 2018/105712 A
Patent Document 2: JP-A-2021-148851

### SUMMARY OF THE INVENTION

### Problems to be Solved by the Invention

In the conventional spot size converter and optical path conversion unit, the optical path length between each of the plurality of waveguide cores and the core of the optical fiber may be long, and there is room for improvement in downsizing.

One object of the present invention is to provide an optical system capable of connecting two optical waveguides having different sizes and capable of shortening an optical path length as compared with a conventional optical system.

### Means for Solving the Problems

The present invention provides an optical system as shown below.
[1] An optical system including a first waveguide, a second waveguide having a light spot size different from a light spot size of the first waveguide, and a metalens optically connecting a first end face of the first waveguide and a second end face of the second waveguide, wherein the metalens includes a first surface facing the first waveguide and a second surface facing a side opposite to the first surface, the metalens is formed with a through hole penetrating between the first surface and the second surface, the through hole has a hole diameter smaller than a target wavelength, the metalens is made of a conductor, at least the first surface of the metalens is formed with a plurality of uneven structures including the first surface and a plurality of annular grooves recessed with respect to the first surface, and the plurality of uneven structures are annularly formed surrounding the through hole in plan view.
[2] The optical system according to [1], wherein a ratio (P/λ) of an interval P (unit: nm) of each of the plurality of uneven structures to the target wavelength A (unit: nm) is 30% or more and 140% or less.
[3] The optical system according to [2], wherein a ratio (W5/P) formed by a width W5 (unit: nm) of each of the plurality of annular grooves to the interval P of each of the plurality of uneven structures in a radial direction with respect to a central axis of the through hole is 10% or more and 95% or less.
[4] The optical system according to any one of [1] to [3], wherein a center of each of the plurality of uneven structures overlaps a center of the through hole in plan view.
[5] The optical system according to any one of [1] to [3], wherein centers of the plurality of uneven structures do not overlap a center of the through holes in plan view.
[6] The optical system according to [5], wherein the centers of the plurality of uneven structures are arranged on a same straight line at equal distances from each other, a central axis of the through hole and a central axis of the second waveguide form a first angle θ₁, and the first angle θ₁ is 3° or more and 60° or less.
[7] The optical system according to [6], wherein when the first angle θ₁ is 5° or more, the interval P and the distance S (unit: nm) satisfy Relational Expression (1) shown below.

$$\begin{matrix}[ Mathematical Formula 1 ] & \\ \frac{P}{( 0.036 {θ}_{1} - \frac{0.1123}{{θ}_{1}} + 0.0671 )} \leq S \leq \frac{P}{( 0.066 {θ}_{1} - \frac{0.0605}{{θ}_{1}} + 0.0671 )} & ( 1 )\end{matrix}$$

[8] The optical system according to any one of [1] to [7], the optical system further comprising a substrate including a third surface that is transparent to light having the target wavelength and is in contact with the second surface of the metalens, wherein each of the plurality of annular grooves penetrates between the first surface and the second surface of the metalens and is formed to expose a part of the third surface.
[9] An optical system including a first waveguide, a second waveguide having a light spot size different from a light spot size of the first waveguide, a metalens optically connecting a first end face of the first waveguide and a second end face of the second waveguide, and a substrate having a third surface that is transparent to light having a target wavelength and intersects with a propagation direction of the light, wherein
the metalens is a phase grating that is disposed on the third surface and gives a phase difference to the light having the target wavelength, the metalens includes a plurality of protrusions disposed on the third surface at an interval between each other, and
each of the plurality of protrusions includes a first group of protrusions disposed at an interval between each other on a first region of the third surface and a second group of protrusions disposed at an interval between each other on a second region of the third surface, and at least one of a height, a maximum width, and a pitch of each of the first group of protrusions is different from at least one of a height, a maximum width, and a pitch of each of the second group of protrusions.
[10] The optical system according to [9], wherein the metalens has a periodic structure in which structural units are periodically disposed in a radial direction with respect to a central axis of the metalens, each of the structural units including the first group of protrusions and the second group of protrusions, in which at least one of a height, a maximum width, and a pitch of each of the plurality of protrusions changes continuously or stepwise.
[11] The optical system according to [9], wherein among the plurality of structural units included in the periodic structure of the metalens, a radial width of a first structural unit at a position closest to the central axis is wider than a radial width of a second structural unit at a position second closest to the central axis.
[12] The optical system according to [11], wherein the radial width of the first structural unit is 1.00 μm or more and 7.00 μm or less.
[13] The optical system according to [9], wherein each of the plurality of protrusions is a columnar body or a spherical body, and
each of the plurality of protrusions has a maximum width shorter than the target wavelength.
[14] The optical system according to any one of [9] to [13], wherein a light condensing angle formed by a first virtual straight line with respect to a second virtual straight line is 20° or more and 70° or less, the first virtual straight line connecting: an outermost end portion positioned at the third surface side of a protrusion among the plurality of protrusions, the protrusion being positioned outermost in a radial direction with respect to a central axis of the metalens; and an intersection between a central axis of the second waveguide and the second end face, the second virtual straight line connecting: an intersection between the central axis of the metalens and the third surface; and an intersection between the central axis of the second waveguide and the second end face.
[15] The optical system according to [1] or [9], wherein the first waveguide is at least one core of an optical fiber, the second waveguide is a fine wire waveguide, a rib type waveguide, or a photonic crystal waveguide, and the metalens is disposed between the first waveguide and the second waveguide.
[16] The optical system according to [15], wherein a ratio of an area of the first end face to an area of the second end face is 10 or more.
[17] The optical system according to [15], wherein the first waveguide includes a plurality of cores discretely disposed, and the metalens optically connects each of the plurality of cores and the second waveguide.
[18] The optical system according to [17], wherein the metalens is provided such that light emitted from each of the plurality of cores is focused on a same straight line as a central axis of each of the first waveguide and the second waveguide.
[19] The optical system according to [1] or [9], the optical system further including an information output unit optically connected to one of the first waveguide and the second waveguide, and an information input unit optically connected to the other of the first waveguide and the second waveguide.
[20] The optical system according to [19], wherein the information output unit is optically connected to the first waveguide, and the information input unit is optically connected to the second waveguide.

### Effect of the Invention

The present invention can provide an optical system capable of connecting two optical waveguides having different sizes, the optical system having a shorter optical path length than a conventional optical system.

### BRIEF DESCRIPTION OF THE DRAWINGS

FIG. 1 is an exploded perspective view for describing an optical system according to a first embodiment.

FIG. 2 is a front view for describing the metalens illustrated in FIG. 1.

FIG. 3 is a sectional view of the metalens and a substrate as viewed from the arrow III-III in FIG. 2.

FIG. 4 is a sectional view for describing the optical system according to the first embodiment.

FIG. 5 is a front view for describing a first modification of the metalens of the optical system according to the first embodiment.

FIG. 6 is a sectional view of the metalens and a substrate as viewed from the arrow VI-VI in FIG. 5.

FIG. 7 is a sectional view for describing a first example of an optical system including the metalens illustrated in FIGS. 5 and 6.

FIG. 8 is a sectional view for describing a second example of an optical system including the metalens illustrated in FIGS. 5 and 6.

FIG. 9 is a sectional view for describing a modification of the metalens illustrated in FIGS. 5 and 6.

FIG. 10 is a sectional view for describing a second modification of the metalens of the optical system according to the first embodiment.

FIG. 11 is a sectional view for describing a third modification of the metalens of the optical system according to the first embodiment.

FIG. 12 is a sectional view for describing a fourth modification of the metalens of the optical system according to the first embodiment.

FIG. 13 is an exploded perspective view for describing an optical system according to a second embodiment.

FIG. 14 is a partially enlarged front view for describing a metalens illustrated in FIG. 13.

FIG. 15 is a partially enlarged perspective view for describing the metalens illustrated in FIGS. 13 and 14.

FIG. 16 is a sectional view for describing a light condensing angle of the metalens of the optical system according to the second embodiment.

FIG. 17 is an exploded perspective view for describing an optical system according to a third embodiment.

FIG. 18 is a partially enlarged perspective view for describing a metalens illustrated in FIG. 17.

FIG. 19 is an exploded perspective view for describing an optical system according to a fourth embodiment.

FIG. 20 is an exploded perspective view for describing an optical system according to a fifth embodiment.

FIG. 21 is an exploded perspective view for describing an optical system according to a sixth embodiment.

FIG. 22 is a partially enlarged plan view for describing an example of a metalens of the optical system according to the sixth embodiment.

FIG. 23 is an exploded perspective view for describing a modification of the optical system according to the sixth embodiment.

FIG. 24 is a diagram for describing a first example of an optical system according to a seventh embodiment.

FIG. 25 is a diagram for describing a second example of the optical system according to the seventh embodiment.

### MODE FOR CARRYING OUT THE INVENTION

Hereinafter, embodiments of the present invention will be described with reference to the drawings. In the following drawings, the same or corresponding parts are denoted by the same reference numerals, and the description thereof will not be repeated.

In the present embodiment, when geometric words and words representing positions, directions, and magnitude relationships, for example, words such as “orthogonal”, “coaxial”, and “equivalent” are used, these words allow production errors or slight variations.

### <Configuration of Optical System>

An optical system according to the present embodiment includes a first waveguide, a second waveguide having a light spot size different from that of the first waveguide, and a metalens that optically connects the first waveguide and the second waveguide.

In the present specification, the “light spot size” means the width of a region where the optical power becomes 1/e² of the maximum value when the optical power distribution of propagating light is assumed to be Gaussian. The first waveguide includes a first end face facing the metalens. The second waveguide includes a second end face facing the metalens. In the present specification, a light spot size on the first end face of the first waveguide is referred to as a “light spot size” of the first waveguide. The light spot size on the second end face of the second waveguide is referred to as a “light spot size” of the second waveguide. The light spot size of the first waveguide is larger than the light spot size of the second waveguide.

In the present specification, the “metalens” means a structure including at least one metasurface and condensing light incident from one of the first end face of the first waveguide and the second end face of the second waveguide on the other. In the present specification, the “metasurface” means a structure including a plurality of electromagnetic wave scatterers arrayed in a direction intersecting a direction in which light propagates between the first end face and the second end face. The plurality of electromagnetic wave scatterers may be arrayed in a direction orthogonal to the propagation direction of light between the first end face and the second end face. The plurality of electromagnetic wave scatterers may be arrayed in a direction inclined at an obtuse angle or an acute angle with respect to the propagation direction of light between the first end face and the second end face.

The light condensing principle of the metalens according to the present exemplary embodiment is not particularly limited, but representative examples thereof will be listed below. In a first example, in a metalens in which a minute opening having an opening width smaller than a target wavelength is formed, light leaking from the minute opening when light of a target wavelength is emitted is collected. In the first example, preferably, the metasurface is provided so as to collect light in the minute opening and enhance the intensity of light leaking from the minute opening. The metalens of the first example has, for example, a metasurface having a bullseye structure. In a second example, in a metalens in which a phase grating is formed, when light having a target wavelength is emitted, light diffracted at a spatially different portion of the phase grating is condensed by giving a phase difference to the light. The metalens of the second example may include a resonant type phase grating provided so as to give a phase difference by resonating light with a plurality of fine particles made of, for example, a metal or a dielectric. The metalens of the second example may include, for example, a waveguide type phase grating provided so as to give a phase difference to light propagating through each of a plurality of dielectric waveguides or metal gap waveguides (metal-insulator-metal (MIM) waveguides).

In the optical system according to the present embodiment, the light having the target wavelength may be propagated from the first waveguide having a relatively large light spot size to the second waveguide having a relatively small light spot size via the metalens. The optical system according to the present embodiment is particularly suitable for a mode in which light propagates from the first waveguide having a relatively large light spot size to the second waveguide having a relatively small light spot size via the metalens. On the other hand, in the optical system according to the present embodiment, the light having the target wavelength may be propagated from the second waveguide to the first waveguide through the metalens in the direction opposite to the above direction. In the latter case, when the focal point of the metalens is on the second end face of the second waveguide, the diameter of the light to be emitted from the second end face is increased via the metalens, and then the light is emitted as parallel light to the first end face side of the first waveguide.

In the present specification, the light spot size on the first end face of light propagating from the metalens to the first end face is referred to as a first light spot size. The light spot size on the second end face of the light propagating from the metalens to the second end face is referred to as a second light spot size. Preferably, a metalens 3 is provided such that the difference between the first light spot size and the light spot size of a core 1A is as small as possible, and the difference between the second light spot size and the light spot size of a Si waveguide 2A is as small as possible. Such a configuration improves the light transmission efficiency between the first waveguide and the second waveguide. More preferably, the metalens is provided such that the first light spot size is equal to the light spot size of the core 1A and the second light spot size is equal to the light spot size of the Si waveguide 2A. Such a configuration maximizes the light transmission efficiency between the first waveguide and the second waveguide.

When light propagates from the first waveguide to the second waveguide, the metalens condenses the light incident from the first waveguide on the second waveguide. In other words, the metalens reduces the spot size of the light incident from the first waveguide to the same extent as the second light spot size. When light propagates from the second waveguide to the first waveguide, the metalens causes a process opposite to the former case and spreads the light incident from the second waveguide to the first waveguide. In other words, the metalens increases the spot size of the light incident from the second waveguide to the same extent as the first light spot size.

Since the optical system according to the present embodiment includes the metalens, an optical path length between the first waveguide and the second waveguide can be shortened as compared with a conventional optical system including a polymer waveguide that optically connects the first waveguide and the second waveguide.

In the present specification, the “plan view” means a viewpoint when the metalens is viewed from a direction in which light propagates between the first waveguide and the second waveguide (hereinafter, also referred to as optical axis direction). In plan view, the alignment of the plurality of electromagnetic wave scatterers is periodic or aperiodic. At least one of a dimension (hereinafter, also referred to as thickness) in the optical axis direction of each of the plurality of electromagnetic wave scatterers, a dimension (hereinafter, also referred to as width) in a direction orthogonal to the optical axis direction, and an interval between two adjacent electromagnetic wave scatterers is equal to or less than a wavelength (hereinafter, also referred to as target wavelength) of light propagating through the optical system. Preferably, the thickness, the width, and the interval of each of the plurality of electromagnetic wave scatterers are all equal to or less than the target wavelength.

Any one of the thickness, the width, and the interval of each of the plurality of electromagnetic wave scatterers may exceed the target wavelength, for example. In this case, another parameter among the thickness, the width, and the interval of each of the plurality of electromagnetic wave scatterers is less than the target wavelength. In this case, the thickness, the width, or the interval of each of the plurality of electromagnetic wave scatterers exceeding the target wavelength is twice or less the target wavelength.

The target wavelength is not particularly limited, but is, for example, 300 nm or more and 3 mm or less. In other words, the optical system is provided so as to propagate at least one of visible light, infrared rays, and terahertz waves, for example.

The first waveguide according to the present embodiment is, for example, a core of an optical fiber. The first waveguide is, for example, a core of a single-core fiber or a multicore fiber. The second waveguide according to the present embodiment is, for example, a fine wire waveguide, a rib type waveguide, or a photonic crystal waveguide.

Hereinafter, an optical system according to the present embodiment will be exemplified.

### First Embodiment

### <Configuration of Optical System 101>

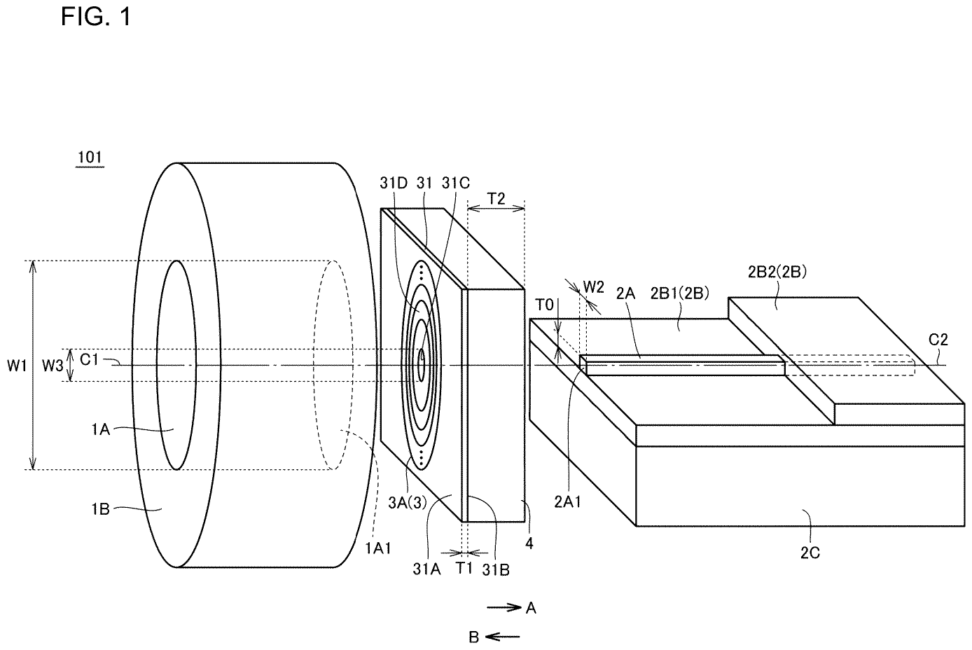

As illustrated in FIG. 1, an optical system 101 according to the first embodiment includes an optical fiber 1, a photonics device 2, a metalens 3, and a substrate 4. The target wavelength of the optical system 101 is longer than 1100 nm at which basic absorption may occur in silicon (Si), and is, for example, 1260 nm or more and 1565 nm or less.

### (1) Optical Fiber

The optical fiber 1 is a single-core fiber including a core 1A as a first waveguide and a cladding 1B. The optical fiber 1 is, for example, a single-mode fiber that propagates light having the target wavelength in a single mode. The core 1A includes a first end face 1A1 facing the metalens 3. The first end face 1A1 is a plane intersecting with a central axis C1 of the core 1A. The first end face 1A1 is, for example, orthogonal to the central axis C1 of the core 1A. The shape of the first end face 1A1 is, for example, a circular shape. The cladding 1B covers the core 1A in a circumferential direction with respect to the central axis C1 of the core 1A. The refractive index of the material constituting the core 1A is higher than the refractive index of the material constituting the cladding 1B. A dimension (core diameter W1) of the first end face 1A1 of the core 1A is, for example, 1 μm or more and 20 μm or less, and preferably 5 μm or more and 10 μm or less.

The optical fiber 1 may be a multi-mode fiber that propagates light of the target wavelength in multiple modes. In this case, the core diameter W1 of the core 1A may be, for example, 20 μm or more and 70 μm or less.

### (2) Photonics Device

The photonics device 2 is a silicon photonics device. The photonics device 2 includes a Si waveguide 2A as a second waveguide, a cladding 2B, and a Si substrate 2C. The Si waveguide 2A is made of Si. The Si waveguide 2A is a so-called thin wire waveguide. The Si waveguide 2A includes a second end face 2A1 facing the metalens 3. The second end face 2A1 is a plane intersecting with a central axis C2 of the Si waveguide 2A. The second end face 2A1 is, for example, orthogonal to the central axis C2 of the Si waveguide 2A. The shape of the second end face 2A1 is, for example, a quadrilateral shape, and is preferably a square shape. The cladding 2B covers the Si waveguide 2A in a circumferential direction with respect to the central axis C2 of the Si waveguide 2A. The material constituting the Si waveguide 2A is higher than the refractive index of the material constituting the cladding 2B. The material constituting the Si waveguide 2A contains, for example, Si or silicon nitride (Si₃N₄).

As illustrated in FIG. 1, the cladding 2B includes a first cladding layer 2B1 and a second cladding layer 2B2. The first cladding layer 2B1 is disposed on the Si substrate 2C and separates the Si waveguide 2A from the Si substrate 2C. The Si waveguide 2A is disposed on the first cladding layer 2B1. The second cladding layer 2B2 is disposed on each of the Si waveguide 2A and the first cladding layer 2B1. The material constituting each of the first cladding layer 2B1 and the second cladding layer 2B2 contains, for example, silicon oxide (SiO₂).

As illustrated in FIG. 1, at least a part of the second cladding layer 2B2 may be an air cladding layer. The entire second cladding layer 2B2 may be an air cladding layer.

The light spot size of the Si waveguide 2A is smaller than the light spot size of the core 1A. Each of a width W2 and a thickness T0 of the second end face 2A1 of the Si waveguide 2A is smaller than the core diameter W1 of the core 1A. Each of the width W2 and the thickness To of the Si waveguide 2A is less than 1 μm, preferably 100 nm or more and less than 500 nm. For example, when the Si waveguide 2A has a trapezoidal shape, and the width W2 may have a long or short width, it is preferable that the shorter width satisfies the length described above, and it is more preferable that both the long and short widths satisfy the length described above. The area (hereinafter, also referred to as first area) of the first end face 1A1 of the core 1A is larger than the area (hereinafter, also referred to as second area) of the second end face 2A1 of the Si waveguide 2A. The ratio of the first area to the second area may be 10 or more, 25 or more, 50 or more, 100 or more, 500 or more, or 1000 or more.

### (3) Metalens

The metalens 3 optically connects the first end face 1A1 of the core 1A and the second end face 2A1 of the Si waveguide 2A.

As illustrated in FIGS. 1 to 3, the metalens 3 includes a metasurface 3A having a bullseye structure. That is, the light condensing principle of the metalens 3 of the optical system 101 applies in the first example. The metasurface 3A is formed in a conductor layer 31.

The conductor layer 31 includes a first surface 31A facing the first end face 1A1 of the core 1A and a second surface 31B positioned on the side opposite to the first surface 31A. Each of the first surface 31A and the second surface 31B is, for example, orthogonal to each of the central axis C1 of the core 1A and the central axis C2 of the Si waveguide 2A. The material constituting the conductor layer 31 may be any conductor as long as surface plasmon can be resonantly excited when light having the target wavelength has entered, but is preferably an inorganic material, and may include, for example, gold, silver, copper, platinum, aluminum, or an alloy thereof. The material constituting the conductor layer 31 preferably contains silver.

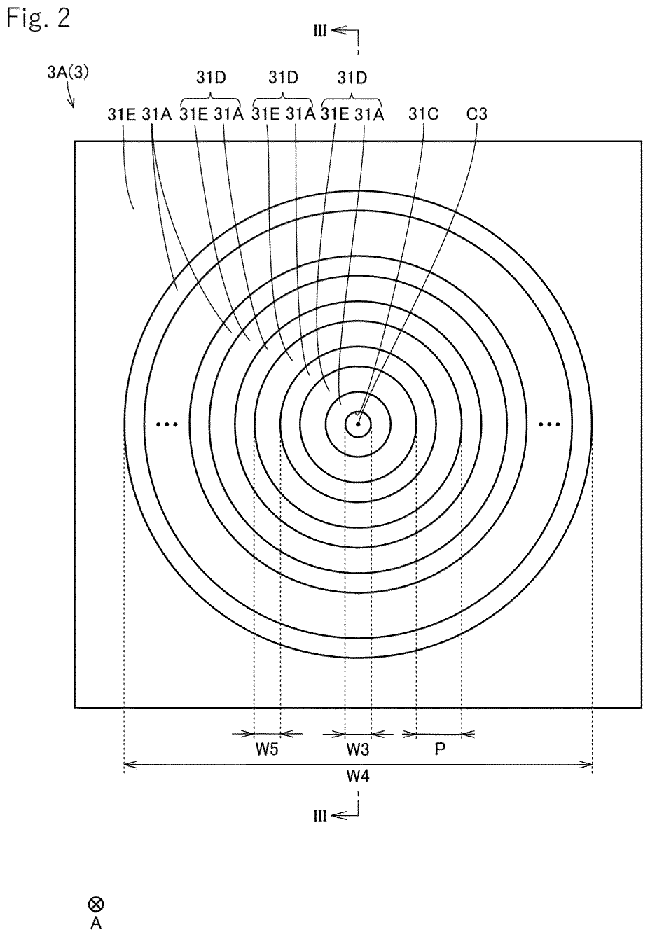

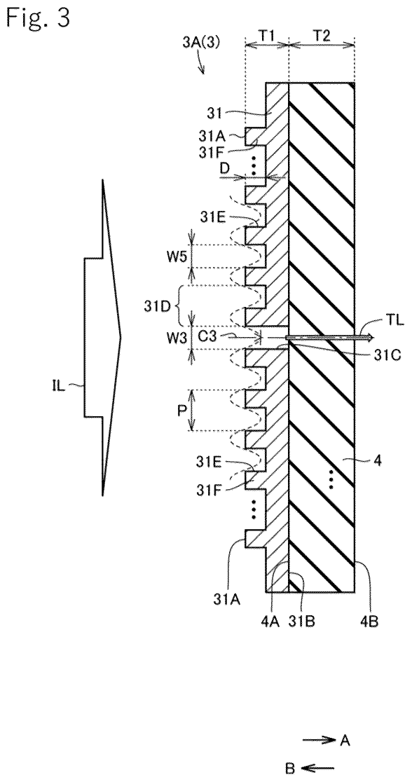

As illustrated in FIGS. 2 and 3, a through hole 31C as a minute opening portion is formed in the conductor layer 31. The through hole 31C penetrates between the first surface 31A and the second surface 31B. The planar shape of the through hole 31C is, for example, a circular shape.

In plan view, at least a part of the through hole 31C is disposed so as to overlap the core 1A and the Si waveguide 2A. Preferably, a central axis C3 (hole axis) of the through hole 31C is disposed so as to overlap the core 1A and the Si waveguide 2A in plan view. More preferably, the central axis C3 of the through hole 31C is disposed on the same straight line as each of the central axis C1 of the core 1A and the central axis C2 of the Si waveguide 2A.

As illustrated in FIGS. 2 and 3, a plurality of uneven structures 31D are formed on the first surface 31A of the conductor layer 31. The plurality of uneven structures 31D includes the first surface 31A and a plurality of annular grooves 31E recessed with respect to the first surface 31A. In a different point of view, a plurality of protrusions 31F (see FIG. 3) protruding from the bottom surfaces of the plurality of annular grooves 31E and having the first surface 31A are formed in the conductor layer 31.

As illustrated in FIG. 2, in plan view, each of the plurality of uneven structures 31D is formed in an annular shape so as to surround the through hole 31C. In plan view, the center each of the plurality of uneven structures 31D overlap each other. In plan view, the center of each of the plurality of uneven structures 31D overlaps the center (central axis C3) of the through hole 31C.

The number of the uneven structures 31D is not particularly limited, but it may be 3 or more and 30 or less. When the number of uneven structures is small, the range of the target wavelength showing the light condensing performance can be widened, and when the number of uneven structures is large, the range of the target wavelength is narrowed, and the wavelength selectivity can be enhanced.

The surfaces of the plurality of uneven structures 31D, that is, the wall surfaces and bottom surfaces of the first surface 31A and the plurality of annular grooves 31E are in contact with, for example, air. The surfaces of the plurality of uneven structures 31D may be in contact with any dielectric. The metalens 3 may further include a dielectric film covering the surface of each of the plurality of annular grooves 31E. The plurality of uneven structures 31D may be planarized by a dielectric film.

As illustrated in FIGS. 2 and 3, the outer peripheral edge of the plurality of uneven structures 31D is configured by, for example, an annular groove 31E. The dimensions of the plurality of uneven structures 31D are, for example, equal to each other. Preferably, a width W4 of the outer peripheral edge of the plurality of uneven structures 31D is equal to the core diameter W1 of the core 1A.

The outer peripheral edge of the plurality of uneven structures 31D may be constituted by the first surface 31A. The plurality of uneven structures 31D may include the first surface 31A and a plurality of annular protrusions protruding from the first surface 31A. In this case, the outer peripheral edge of the plurality of uneven structures 31D may be formed of the annular protrusion or may be formed of the first surface 31A.

In the optical system 101, the propagation direction of light is not limited. Light may propagate from the core 1A having a relatively large light spot size to the Si waveguide 2A having a relatively small light spot size via the metalens 3 along the direction A (see FIGS. 1 to 3). In the opposite direction, light may propagate from the Si waveguide 2A to the core 1A via the metalens 3 along the direction B (See FIGS. 1 and 3). The direction A and the direction B are, for example, along a horizontal direction. The direction A and the direction B may be along a vertical direction.

The light spot size on the first end face 1A1 of the light propagating from the metalens 3 to the first end face 1A1 (hereinafter, also referred to as first light spot size) is larger than the light spot size of the Si waveguide 2A, and is preferably equal to the light spot size of the core 1A. The light spot size on the second end face 2A1 of the light propagating from the metalens 3 to the second end face 2A1 (hereinafter, also referred to as second light spot size) is smaller than the light spot size of the core 1A, and is preferably equal to the light spot size of the Si waveguide 2A.

The metalens 3 including the metasurface 3A is provided so as to resonantly excite surface plasmon when light having the target wavelength is incident on the metasurface 3A from the core 1A, collect the surface plasmon into the through hole 31C serving as a minute opening portion, and emit light having the second light spot size to the Si waveguide 2A. The metalens 3 is provided so as to emit light having the first light spot size to the core 1A through a process opposite to the above process when light having the target wavelength has entered the through hole 31C from the Si waveguide 2A.

The dimensions of each of the conductor layer 31, the through hole 31C, and the plurality of uneven structures 31D constituting the metasurface 3A may be freely selected according to the target wavelength. A thickness T1 (see FIG. 1) of the conductor layer 31 is not particularly limited, but may be preferably the target wavelength or less, more preferably less than the target wavelength, more preferably half the target wavelength or less, and it may be 50 nm or more. When the target wavelength is 1260 nm or more and 1565 nm or less as described above, the thickness T1 may be about 300 nm. A hole diameter W3 of the through hole 31C is equal to or less than the target wavelength, and is preferably smaller than the target wavelength. The hole diameter W3 is, for example, about half the target wavelength. A width W5 of each of the plurality of annular grooves 31E and a depth D of each of the plurality of annular grooves 31E in a radial direction with respect to the central axis C3 of the through hole 31C are each equal to or less than the target wavelength, and are preferably smaller than the target wavelength. The width W5 of each of the plurality of annular grooves 31E and the depth D of each of the plurality of annular grooves 31E are, for example, about half the target wavelength.

An interval P of each of the plurality of uneven structures 31D in the radial direction with respect to the central axis C3 of the through hole 31C is not particularly limited, but is equal to the target wavelength. The interval of the plurality of uneven structures means a pitch (period) between adjacent protrusions or between adjacent recesses. Specifically, as illustrated in FIG. 3, the interval means the interval (width) P of one uneven structure 31D. From the viewpoint of enhancing the light condensing performance, the ratio of the interval P of each of the plurality of uneven structures 31D to the target wavelength is preferably 30% or more and 200% or less. The ratio of the interval P of each of the plurality of uneven structures 31D to the target wavelength is preferably 140% or less, more preferably 110% or less, and still more preferably less than 100%. The ratio of the interval P of each of the plurality of uneven structures 31D to the target wavelength is preferably 60% or more, more preferably more than 65%, and still more preferably 70% or more.

The ratio (W5/P) of the width W5 of each of the plurality of annular grooves 31E to the interval P of each of the plurality of uneven structures 31D in the radial direction with respect to the central axis C3 of the through hole 31C is not particularly limited, but it may be 10% or more and 95% or less. From the viewpoint of further increasing the ratio of the transmittance to the reflectance of the target wavelength, the ratio W5/P is preferably 30% or more, more preferably 45% or more, still more preferably 60% or more, particularly preferably 70% or more, and still more particularly preferably 80% or more.

The second surface 31B of the metalens 3 is, for example, a flat surface.

The method for forming the metalens 3 is not particularly limited. The metalens 3 may be formed as follows. First, the conductor layer 31 is formed on the third surface 4A of the substrate 4. The method for forming the conductor layer 31 may be any method, and the method may be, for example, a sputtering method or the like. Second, the conductor layer 31 is patterned to form the through hole 31C and the plurality of annular grooves 31E. The method for patterning the conductor layer 31 may be any method, and the method may be, for example, photolithography, dry etching, or the like.

### (4) Substrate

As illustrated in FIGS. 1 and 3, the substrate 4 supports the metalens 3. The substrate 4 is transparent to light having the target wavelength. The substrate 4 includes a third surface 4A in contact with the second surface 31B of the metalens 3 and a fourth surface 4B positioned on the side opposite to the third surface 4A and facing the second end face 2A1 of the Si waveguide 2A. The third surface 4A is, for example, orthogonal to the central axis C3 of the through hole 31C.

The substrate 4 is not particularly limited, but is preferably made of a material having a low refractive index from the viewpoint of suppressing Fresnel reflection. The substrate 4 may contain, for example, SiO₂, more preferably contains glass, and still more preferably, the substrate is made of glass.

A thickness T2 of the substrate 4 is larger than the thickness T1 of the conductor layer 31, for example. Preferably, the sum of the thickness T1 of the conductor layer 31 and the thickness T2 of the substrate 4 is shorter than the length of the polymer waveguide required when optically connecting the core 1A and the Si waveguide 2A with a conventional polymer waveguide.

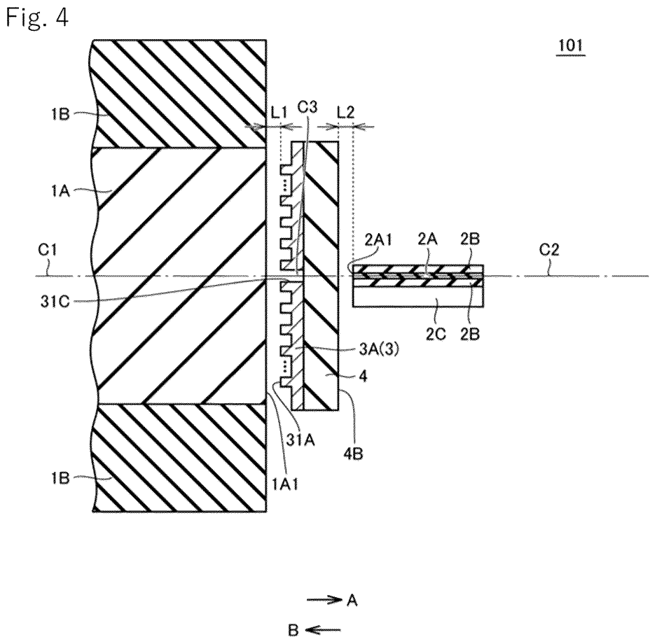

See FIG. 4. The shortest distance L1 between the first end face 1A1 of the core 1A and the first surface 31A of the metalens 3 and the shortest distance L2 between the second end face 2A1 of the Si waveguide 2A and the fourth surface 4B of the substrate 4 are preferably as short as possible. Each of the shortest distance L1 and the shortest distance L2 may be shorter than the thickness T1 (see FIG. 3) of the conductor layer 31 of the metalens 3.

The light propagating through the optical system 101 may sequentially pass through the core 1A, the metalens 3, the substrate 4, and the Si waveguide 2A, or may sequentially pass through the Si waveguide 2A, the substrate 4, the metalens 3, and the core 1A.

### <Effect of Optical System 101>

As described above, since the optical system 101 includes the metalens 3, an optical path length between the core 1A and the Si waveguide 2A may be shortened as compared with an optical system including a polymer waveguide or a convex lens that optically connects the core 1A and the Si waveguide 2A.

In addition, in the optical system 101, as compared with an optical system in which a core of an optical fiber and a Si waveguide are connected by an optical lens, the light transmission efficiency between the core 1A and the Si waveguide 2A is less likely to decrease, even when the relative position of each of the core 1A, the Si waveguide 2A, and the metalens 3 is varied because of a production error or the like. Specifically, in an optical system in which a core of an optical fiber and a Si waveguide are connected by an optical lens, when the distance between the optical lens and the Si waveguide is varied, a focal position of the optical lens is varied greatly with respect to the Si waveguide, and there is a possibility that transmission efficiency is significantly lowered. On the other hand, in the optical system 101, since the through hole 31C is formed in the metalens 3, the light incident on the metalens 3 from the core 1A or the Si waveguide 2A concentrates on the through hole 31C and then passes through the through hole 31C. As a result, in the optical system 101, it can be considered that the focal point of light emitted from the metalens 3 to the Si waveguide 2A or the core 1A is formed in the through hole 31C, and parallel light is incident on the Si waveguide 2A or the core 1A. Thus, in the optical system 101, the light transmission efficiency between the first waveguide and the second waveguide is less likely to be affected by the variation in the shortest distance L1 between the core 1A and the metalens 3 and the shortest distance L2 between the Si waveguide 2A and the substrate 4 due to a production error or the like.

The direction A or the direction B in which light propagates in the optical system 101 may be any direction, and it may be, for example, a horizontal direction or a vertical direction. According to the optical system 101, even when the first end face 1A1 of the optical fiber 1 and the second end face 2A1 of the Si waveguide 2A face each other in the horizontal direction, the first end face 1A1 and the second end face 2A1 can be optically connected to each other without changing the propagation direction of light with a mirror or the like. Thus, the degree of freedom in designing the optical system 101 is higher than that of the conventional optical system.

In the optical system described in Patent Document 2 in which a core of an optical fiber and a Si waveguide are connected by a plurality of mirrors, once the optical axis of each of the plurality of mirrors shifts, it is impossible to correct the shift. On the other hand, in the optical system 101, the relative positions of the core 1A, the Si waveguide 2A, and the metalens 3 can be easily readjusted, and thus a decrease in yield can be suppressed.

In addition, in the optical system 101, the plurality of uneven structures 31D are formed so as to surround the through hole 31C of the metalens 3. With this configuration, when light having the target wavelength is incident on the plurality of uneven structures 31D, surface plasmon resonantly excited gathers in the through hole 31C, and thus light transmitted through the metalens 3 can be more efficiently collected as compared with a case where only the through hole 31C is formed in the conductor layer 31, and the intensity of the light is increased.

As illustrated in FIG. 3, in the optical system 101, the propagation direction of light IL incident on the metalens 3 from the core 1A is set to a direction perpendicular to the first surface 31A. The propagation direction of light TL emitted from the metalens 3 to the Si waveguide 2A is parallel to the propagation direction of the light IL incident on the metalens 3 from the core 1A. Similarly, in the optical system 101, the propagation direction of the light IL incident on the metalens 3 from the Si waveguide 2A is set to a direction perpendicular to the second surface 31B. The propagation direction of the light emitted from the metalens 3 to the core 1A is parallel to the propagation direction of the light IL incident on the metalens 3 from the Si waveguide 2A.

In the optical system 101, the metalens 3 may be made of an inorganic material. In this case, the heat resistance of the optical system 101 is high as compared with an optical system including a polymer waveguide.

### <Modification of Metalens>

Hereinafter, a modification of the metalens 3 of the optical system 101 will be described.

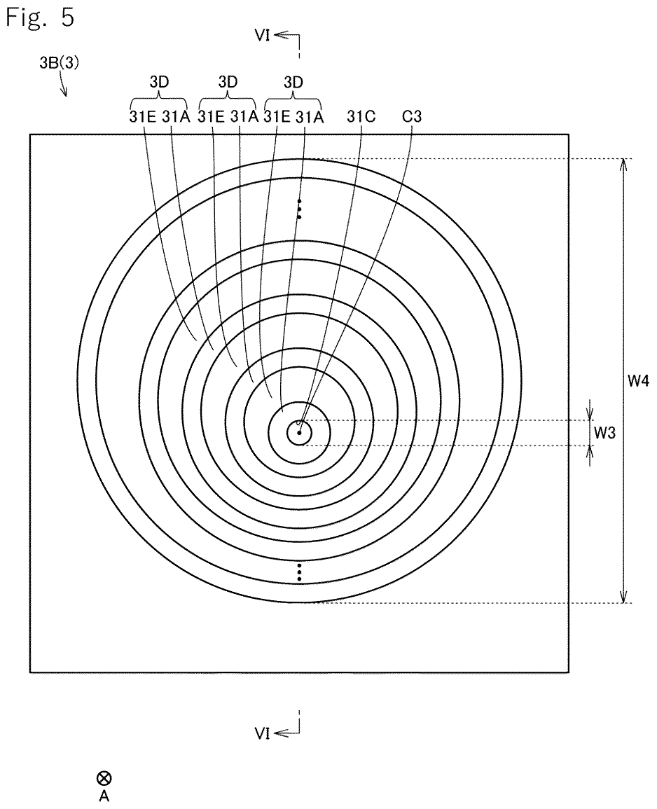

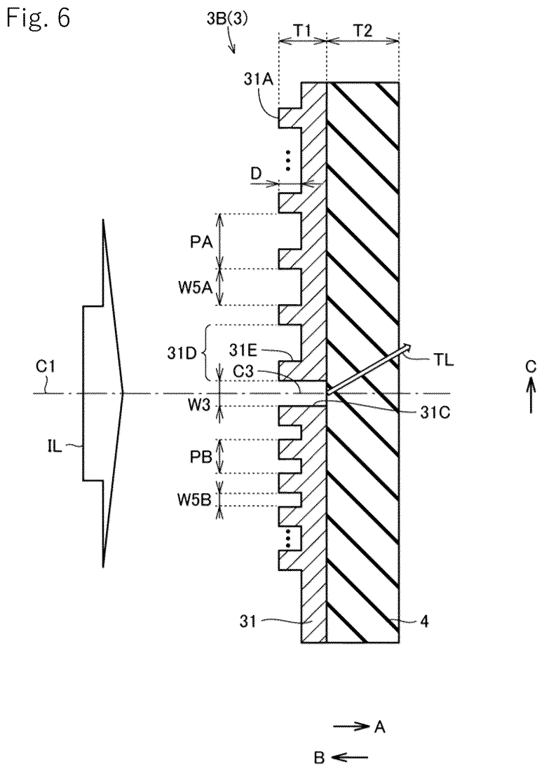

The optical system 101 may include the metalens 3 illustrated in FIGS. 5 and 6 instead of the metalens 3 illustrated in FIGS. 1 to 4. The metalens 3 illustrated in FIGS. 5 and 6 basically have the same configuration as the metalens 3 illustrated in FIGS. 1 to 4, but is different from the metalens 3 illustrated in FIGS. 1 to 4 in that the metalens 3 includes a metasurface 3B instead of the metasurface 3A. The metasurface 3B is different from the metasurface 3A in that the center of each of the plurality of uneven structures 31D is disposed so as not to overlap the center (central axis C3) of the through hole 31C (minute opening) in plan view. That is, the metasurface 3B also has a bullseye structure similarly to the metasurface 3A. Hereinafter, differences of the metalens 3 and the metasurface 3B illustrated in FIGS. 5 and 6 from the metalens 3 and the metasurface 3B illustrated in FIGS. 1 to 4 will be mainly described.

As illustrated in FIGS. 5 and 6, in the direction C orthogonal to the central axis C3 of the through hole 31C, the interval (period) of each portion of the plurality of uneven structures 31D positioned on one side with respect to the through hole 31C is wider than the interval (period) of each portion of the plurality of uneven structures 31D positioned on the other side with respect to the through hole 31C. Hereinafter, the interval of each portion of the plurality of uneven structures 31D positioned on one side of the through hole 31C in the direction C and disposed at a relatively wide interval is also referred to as a first interval PA. The interval of each portion of the plurality of uneven structures 31D positioned on the other side of the through hole 31 C in the direction C and disposed at a relatively narrow interval is also referred to as a second interval PB. The first interval PA of each portion of the plurality of uneven structures 31D positioned on one side with respect to the through hole 31C gradually increases as the distance from the through hole 31C increases. The second interval PB of each portion of the plurality of uneven structures 31D positioned on the other side with respect to the through hole 31C is, for example, equal to each other.

In other words, in the first direction C orthogonal to the central axis C3 of the through hole 31C, the width (hereinafter, also referred to as first width W5A) of each portion of the plurality of annular grooves 31E positioned on one side with respect to the through hole 31C is larger than the width (hereinafter, also referred to as second width W5B) of each portion of the plurality of annular grooves 31E positioned on the other side with respect to the through hole 31C. The first width W5A of each portion of the plurality of annular grooves 31E positioned on one side with respect to the through hole 31C gradually increases as the distance from the through hole 31C increases. The second widths W5B of each portion of the plurality of annular grooves 31E positioned on the other side with respect to the through hole 31C is equal to each other, for example.

Also in the metasurface 3B illustrated in FIGS. 5 and 6, the plurality of uneven structures 31D may have a region in which the ratio of the interval P to the target wavelength is 30% or more and 200% or less. The ratio of the first interval PA of each of the plurality of uneven structures 31D to the target wavelength may be, for example, 200% or less, preferably 140% or less, more preferably 110% or less, and still more preferably less than 100%. Similarly, the ratio of the second interval PB of each of the plurality of uneven structures 31D to the target wavelength may be 30% or more, preferably 60% or more, more preferably more than 65%, and still more preferably 70% or more.

The ratio (W5A/PA) of the first width W5A to the first interval PA and the ratio (W5B/PB) of the second width W5B to the second interval PB are not particularly limited, but they may be 10% or more and 95% or less. From the viewpoint of further increasing the ratio of the transmittance to the reflectance of the target wavelength, each of the ratio W5A/PA and the ratio W5B/PB is preferably 30% or more, more preferably 45% or more, still more preferably 60% or more, and particularly preferably 80% or more.

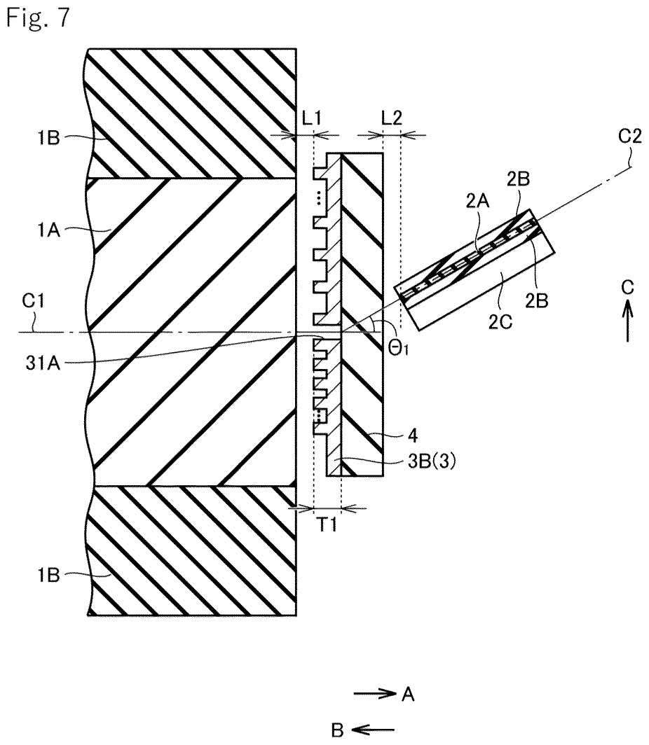

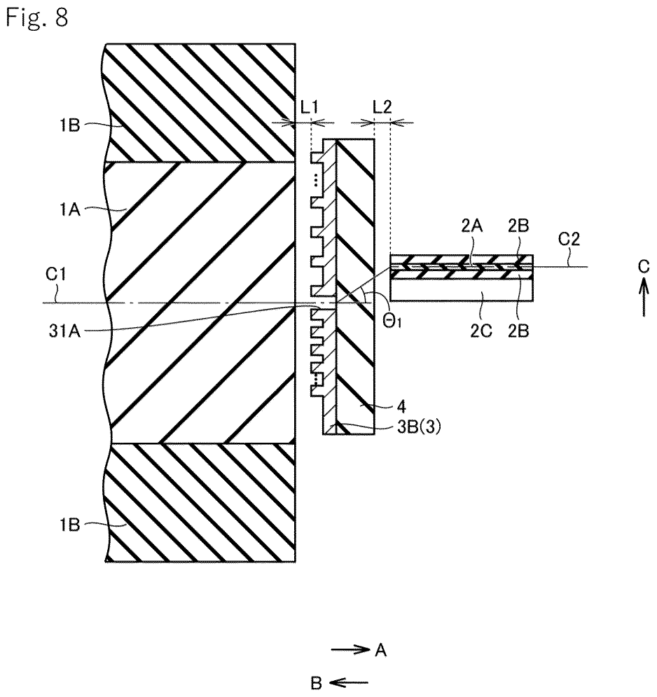

Also in the metalens 3 including the metasurface 3B, the propagation direction of the light IL incident on the metalens 3 from the core 1A is set to a direction perpendicular to the first surface 31A. In the metalens 3 including the metasurface 3B, the propagation direction of the light TL emitted from the metalens 3 to the Si waveguide 2A is inclined with respect to the propagation direction of the light IL incident on the metalens 3 from the core 1A. Thus, as illustrated in FIG. 7, the metalens 3 including the metasurface 3B is suitable for an optical system in which the central axis C2 of the Si waveguide 2A is inclined to the first direction C side with respect to the central axis C1 of the core 1A. In addition, as illustrated in FIG. 8, the metalens 3 including the metasurface 3B is suitable for an optical system in which the central axis C2 of the Si waveguide 2A is parallel to the central axis C1 of the core 1A, and the central axis C1 is disposed at an interval from the central axis C2 in the first direction C. Also in each of the optical systems illustrated in FIGS. 7 and 8, light transmission efficiency between the core 1A and the Si waveguide 2A is high.

FIGS. 7 and 8 illustrate an emission angle θ₁ of the metalens 3 including the metasurface 3B having the bullseye structure. The emission angle θ₁ in FIG. 7 is an angle (first angle) formed by the central axis C2 of the Si waveguide 2A with respect to the central axis C3 (in FIG. 7, C3 coincides with C1) of the through hole 31C. The emission angle θ₁ in FIG. 8 is an angle formed by a straight line connecting an intersection between the central axis C3 of the through hole 31C (in FIG. 8, C3 coincides with C1) and the third surface 4A of the substrate 4 (an end of the central axis C3 of the through hole 31C positioned on the second surface 31B of the metasurface 3B) and an intersection between the central axis C2 of the Si waveguide 2A and the second end face 2A1 of the Si waveguide 2A (an end of the central axis C2 of the Si waveguide 2A positioned on the second end face 2A1 of the Si waveguide 2A) with respect to the central axis C3 of the through hole 31C. The emission angle θ₁ of the metalens 3 including the metasurface 3B is not particularly limited, but it is, for example, 3° or more and 600 or less, and it may be 450 or less. The emission angle θ₁ may be 7° or more, 16° or more, 30° or more, or 40° or more.

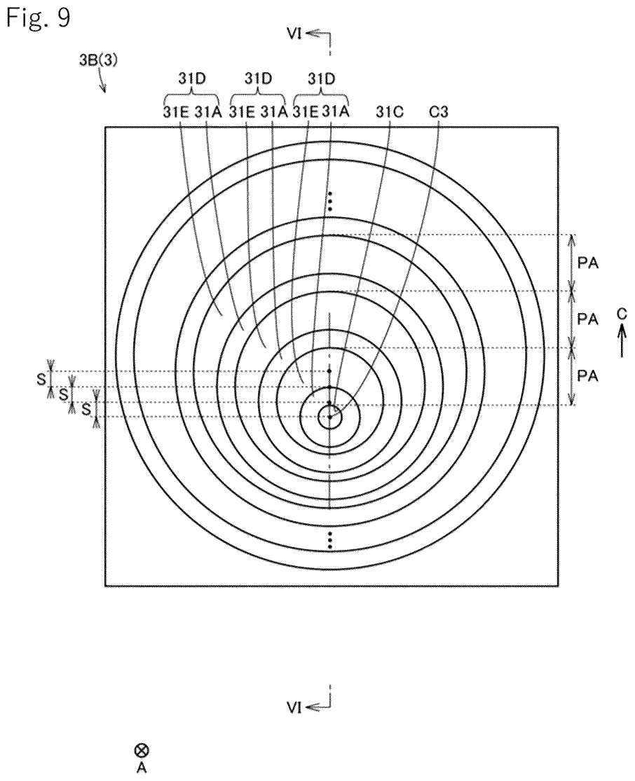

As illustrated in FIG. 9, in the metasurface 3B, distances (hereinafter, also referred to as shift amount) between the centers of the plurality of uneven structures 31D may be equal to each other. In the present specification, in the configuration illustrated in FIG. 9 in which the shift amounts of two adjacent uneven structures 31D in the plurality of uneven structures 31D are equal to each other, each shift amount is referred to as unit shift amount S. In the metalens 3 including the metasurface 3B illustrated in FIG. 9, the ratio (81/S) of the emission angle θ₁ with respect to the unit shift amount S may be 0.19 or more, 0.58 or more, 2.00 or more, 3.33 or more, 6.00 or more, or 10.00 or more.

In the metasurface 3B illustrated in FIG. 9, the first intervals PA are equal to each other, for example. Also in this case, from the viewpoint of enhancing the light condensing performance, the ratio of the first interval PA of each of the plurality of uneven structures 31D to the target wavelength may be, for example, 200% or less, preferably 140% or less, more preferably 110% or less, and still more preferably less than 100%. Similarly, the ratio of the first interval PA of each of the plurality of uneven structures 31D to the target wavelength may be 30% or more, preferably 60% or more, more preferably more than 65%, and still more preferably 70% or more. The first interval PA may gradually increase as the distance from the through hole 31C increases.

The inventors of the present invention have confirmed that, when the emission angle θ₁ to be realized in the metasurface 3B is 5° or more, the emission angle θ₁ can be realized when the unit shift amount S (unit: nm) of the metasurface 3B and the interval P (unit: nm) of the plurality of uneven structures 31D are provided so as to satisfy the following Relational Expression (1).

$$\begin{matrix}[ Mathematical Formula 2 ] & \\ \frac{P}{( 0.036 {θ}_{1} - \frac{0.1123}{{θ}_{1}} + 0.0671 )} \leq S \leq \frac{P}{( 0.066 {θ}_{1} - \frac{0.0605}{{θ}_{1}} + 0.0671 )} . & ( 1 )\end{matrix}$$

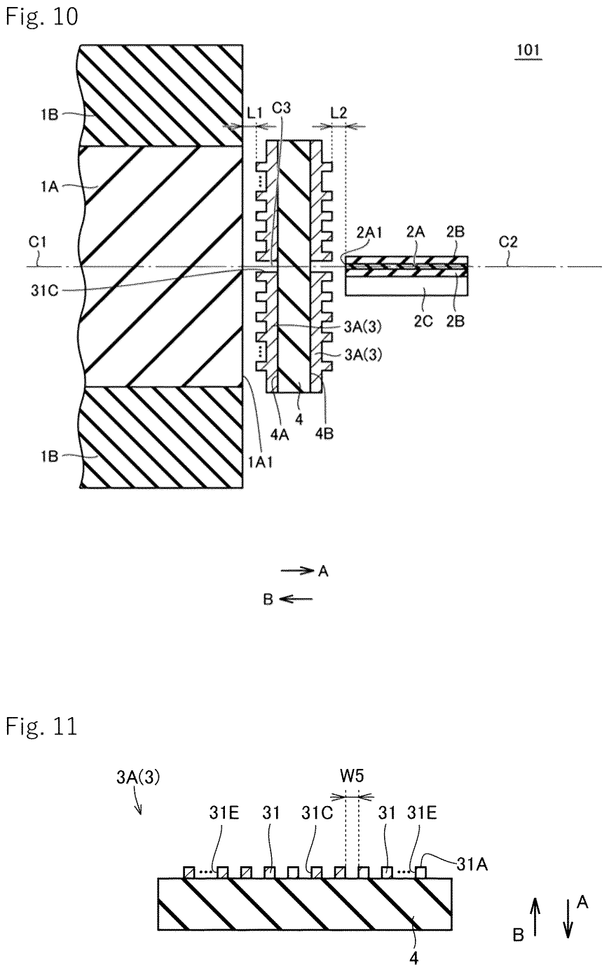

The optical system 101 may include the metalens 3 illustrated in FIG. 10 instead of the metalens 3 illustrated in FIGS. 1 to 6. The metalens 3 illustrated in FIG. 10 has a configuration basically similar to that of the metalens 3 illustrated in FIGS. 1 to 6, but is different from the metalens 3 illustrated in FIGS. 1 to 6 in that the metalens 3 further includes a metasurface 3A disposed on the fourth surface 4B of the substrate 4. The metasurface 3A disposed on the fourth surface 4B is symmetrical to the metasurface 3A disposed on the third surface 4A with respect to the substrate 4. In the metalens 3 illustrated in FIG. 10, the shortest distance between the metasurface 3A disposed on the third surface 4A of the substrate 4 and the first end face 1A1 of the core 1A and the shortest distance between the metasurface 3A disposed on the fourth surface 4B of the substrate 4 and the second end face 2A1 of the Si waveguide 2A are preferably as short as possible.

It is sufficient that the metalens 3 of the optical system 101 includes the metasurface 3A or the metasurface 3B disposed on at least one of the third surface 4A and the fourth surface 4B of the substrate 4.

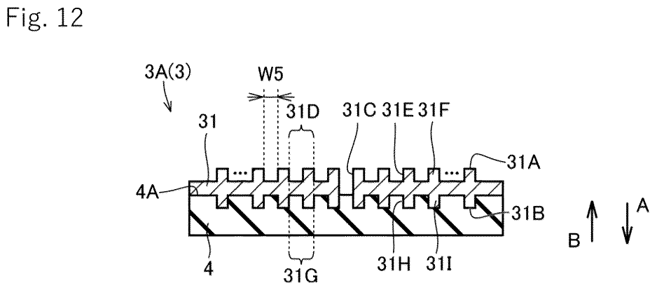

The optical system 101 may include the metalens 3 illustrated in FIG. 11 or FIG. 12 instead of the metalens 3 illustrated in FIGS. 1 to 6.

The metalens 3 illustrated in FIG. 11 has a configuration basically similar to that of the metalens 3 illustrated in FIGS. 1 to 6, but is different from the metalens 3 illustrated in FIGS. 1 to 6 in that each of the plurality of annular grooves 31E in the plurality of uneven structures 31D is formed so as to penetrate between the first surface 31A and the second surface 31B of the metalens 3 and to expose a part of the third surface 4A of the substrate 4. The bottom surface of each annular groove 31E is constituted by the third surface 4A of the substrate 4. In a different point of view, the metalens 3 illustrated in FIG. 11 has a configuration basically similar to that of the metalens 3 illustrated in FIGS. 1 to 6, but is different from the metalens 3 illustrated in FIGS. 1 to 6 in that each of the plurality of uneven structures 31D is constituted by the third surface 4A of the substrate 4 and a plurality of protrusions 31F formed on the third surface 4A of the substrate 4 as island-like patterns separated from each other. In the metalens 3 illustrated in FIG. 11, the depth of each of the plurality of annular grooves 31E is equal to the depth of the through hole 31C.

The metalens 3 illustrated in FIG. 12 basically has the same configuration as the metalens 3 illustrated in FIGS. 1 to 6, but is different from the metalens 3 illustrated in FIGS. 1 to 6 in that a plurality of uneven structures are formed on each of the first surface 31A and the second surface 31B of the conductor layer 31.

For example, a plurality of uneven structures 31G formed on the second surface 31B is in a plane-symmetric relationship with the plurality of uneven structures 31D formed on the first surface 31A with respect to a virtual symmetric plane positioned on a midpoint between the first surface 31A and the second surface 31B. The plurality of uneven structures 31G includes the second surface 31B and a plurality of annular grooves 31H recessed with respect to the second surface 31B. In a different point of view, a plurality of protrusions 31I protruding from the bottom surfaces of the plurality of annular grooves 31H and having the second surface 31B are formed in the conductor layer 31. Each protrusion 31I is disposed so as to overlap a corresponding one of protrusion 31F, for example, in a direction orthogonal to the first surface 31A. The second surface 31B and the wall surfaces and the bottom surfaces of the plurality of annular grooves 31E formed on the second surface 31B are in contact with the third surface 4A of the substrate 4. The width of each of the plurality of annular grooves 31H is equal to the width W5 of the plurality of annular grooves 31E. The metalens 3 illustrated in FIG. 12 can be produced, for example, by forming the plurality of protrusions 31I in a recess of the third surface 4A of the substrate 4 and then forming the rest of the conductor layer 31 on the third surface 4A.

### Second Embodiment

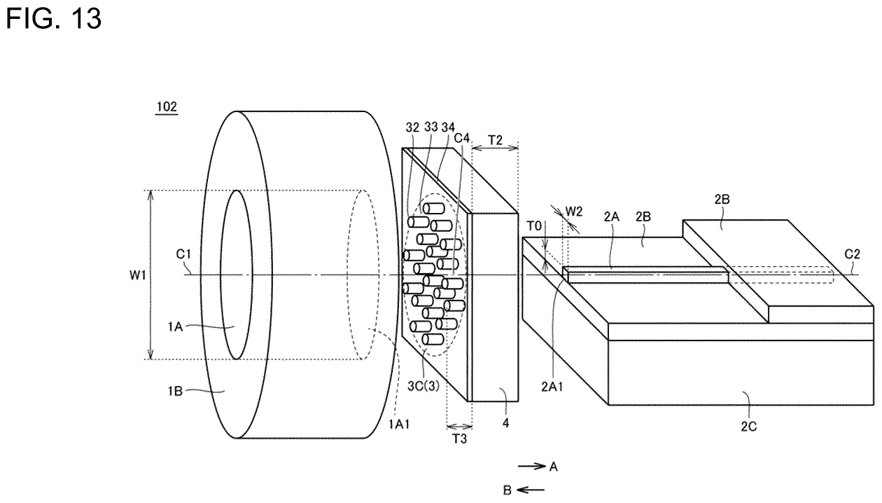

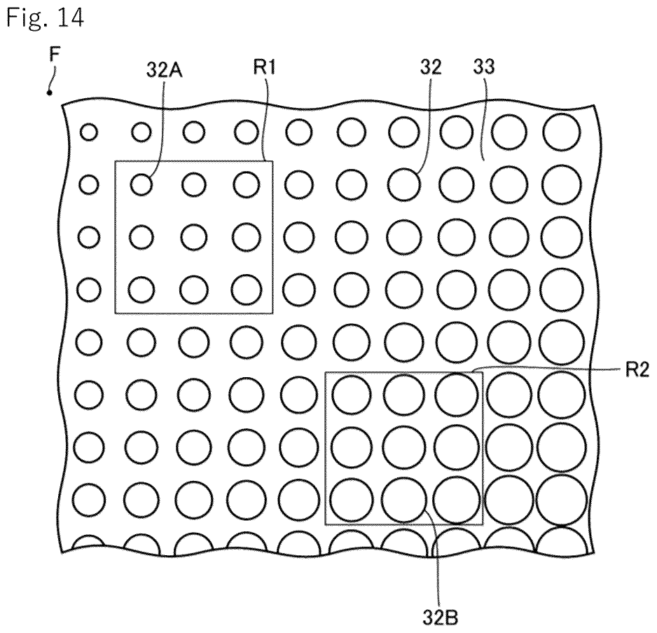

An optical system 102 according to a second embodiment will be described with reference to FIG. 13. The optical system 102 according to the second embodiment has a configuration basically similar to that of the optical system 101 according to the first embodiment, and exhibits a similar effect, but is different from the optical system 101 in that the metalens 3 includes a phase grating disposed on the third surface 4A of the substrate 4 and giving a phase difference to light having the target wavelength. Hereinafter, the differences of the optical system 102 from the optical system 101 will be mainly described.

The metalens 3 of the optical system 102 includes a waveguide type phase grating. The light condensing principle of the metalens 3 of the optical system 102 applies in the second example.

As illustrated in FIG. 13, the metalens 3 includes a metasurface 3C configured by a plurality of columnar bodies 32 (protrusions) disposed on the third surface 4A at an interval between each other and a filling portion 33 filling the space between the plurality of columnar bodies 32. The refractive index of the material constituting each of the plurality of columnar bodies 32 is higher than the refractive index of the material constituting the filling portion 33. The outer shape of each of the plurality of columnar bodies 32 is, for example, a cylinder shape. The central axis of each of the plurality of columnar bodies 32 is parallel to the central axis C1 of the core 1A. The central axis of each of the plurality of columnar bodies 32 is, for example, orthogonal to the third surface 4A of the substrate 4. The material constituting the plurality of columnar bodies 32 and the material constituting the filling portion 33 are not particularly limited as long as the respective refractive indexes satisfy the above relationship. The material constituting the plurality of columnar bodies 32 is, for example, a dielectric, more preferably an inorganic material, and includes Si as a specific example. The surfaces of the plurality of columnar bodies 32 are in contact with, for example, an air layer as the filling portion 33. The filling portion 33 may be formed of a dielectric film. The surfaces of the plurality of columnar bodies 32 may be in contact with the dielectric film. The plurality of columnar bodies 32 may be embedded in the filling portion 33.

As illustrated in FIG. 13, the metalens 3 may further include a base material 34 that is transparent to light having the target wavelength and is disposed on the third surface 4A of the substrate 4. Each of the plurality of columnar bodies 32 may be fixed to the base material 34. The metalens 3 does not have to include the base material 34, and each of the plurality of columnar bodies 32 may be fixed to the third surface 4A of the substrate 4.

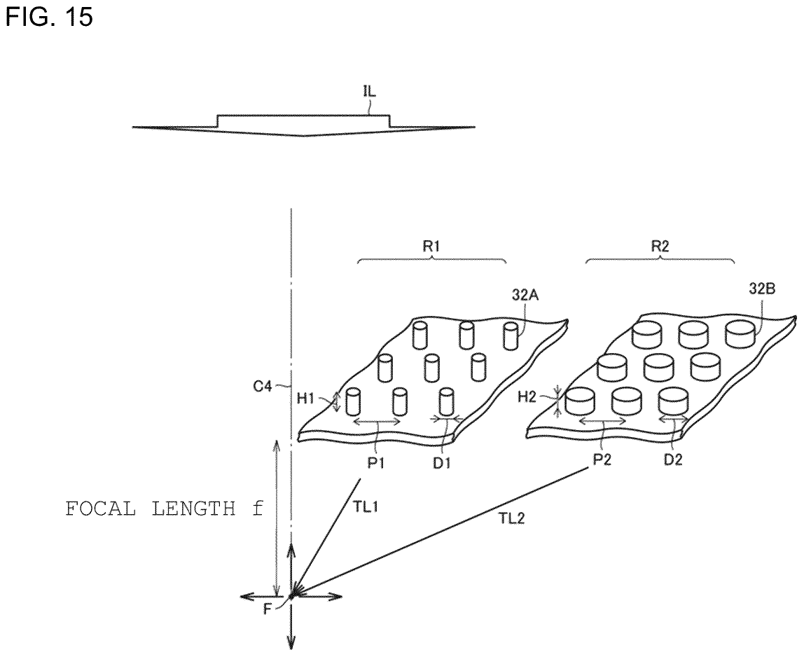

Each of the plurality of columnar bodies 32 forms a waveguide through which light having the target wavelength propagates. The phase of the light incident on each of the plurality of columnar bodies 32 changes in the process of propagating through each columnar body 32. The phase change amount of light propagating through each columnar body 32 increases as the ratio D/P of an outer diameter D (maximum width) of the columnar body 32 to the interval P (pitch) between the columnar body 32 and another columnar body 32 adjacent to the columnar body 32 increases. The position of the focal point F (see FIG. 15) of the metalens 3 changes according to the spatial distribution of the phase of the light passing through each waveguide. Thus, the phase change amount of light propagating through each columnar body 32 may be freely set according to the position where the focal point F of the metalens 3 is to be disposed.

In the optical system 102, at least one of the outer diameter and the height of each of the plurality of columnar bodies 32 and the interval between two adjacent columnar bodies 32 is provided to change continuously or stepwise in the radial direction according to the distance to the focal point.

As illustrated in FIG. 14, in plan view, at least one of the outer diameter of the columnar body 32 and the interval between two adjacent columnar bodies 32 preferably changes continuously or stepwise according to the distance to the focal point. More preferably, in plan view, both the outer diameter of the columnar body 32 and the interval between two adjacent columnar bodies 32 change continuously or stepwise according to the distance to the focal point. Preferably, in plan view, the outer diameter of each of the plurality of columnar bodies 32 is provided so as to increase as the distance from the focal point F of the metalens 3 increases. Preferably, in plan view, the interval between two adjacent columnar bodies 32 is provided so as to decrease as the distance from the focal point F of the metalens 3 increases.

As illustrated in FIGS. 14 and 15, the metalens 3 includes a first region R1 in which the plurality of columnar bodies 32 are disposed such that the phase change amount becomes relatively small, and a second region R2 in which the plurality of columnar bodies 32 are disposed such that the phase change amount becomes relatively large. In plan view, the first region R1 is a region closer to the focal point F than the second region R2. The ratio D2/P2 of the outer diameter D2 of the columnar bodies 32B in a second group formed in the second region R2 to the interval P2 of the columnar bodies 32B in the second group is larger than the ratio D1/P1 of the outer diameter D1 of the columnar bodies 32A in a first group formed in the first region R1 to the interval P1 of the columnar bodies 32A in the first group. With this configuration, the phase change amount of the light TL2 propagated through each of the columnar bodies 32B in the second group is larger than the phase change amount of the light TL1 propagated through each of the columnar bodies 32A in the first group.

When the focal point F is disposed on the same straight line as the central axis C4 of the phase grating of the metalens 3, at least one of the outer diameter of the columnar body 32 and the interval between two adjacent columnar bodies 32 may change continuously or stepwise according to the distance to the central axis C4 in plan view. For example, in plan view, the outer diameter of each of the plurality of columnar bodies 32 may be increased as the distance from the central axis C4 of the metalens 3 increases, and the interval between two adjacent columnar bodies 32 may be decreased as the distance from the central axis C4 of the metalens 3 increases.

The outer diameter of each of the plurality of columnar bodies 32 is equal to or less than the target wavelength. The outer diameter of each of the plurality of columnar bodies 32 is, for example, several 10 nm or more and 1 μm or less. The interval between two adjacent columnar bodies 32 is equal to or less than the target wavelength. The interval between two adjacent columnar bodies 32 is, for example, several 10 nm or more and 1.55 μm or less. The interval between two adjacent columnar bodies 32 means the distance between the central axes of two adjacent columnar bodies 32.

The height H2 of the columnar bodies 32B in the second group is lower than the height H1 of the columnar bodies 32B in the first group, for example. The height H2 of the columnar bodies 32B in the second group may be equal to the height H1 of the columnar bodies 32B in the first group, for example. The maximum value of the height of each of the plurality of columnar bodies 32 is shorter than the thickness of the convex lens for optically connecting the core 1A and the Si waveguide 2A. The maximum value of the height of each of the plurality of columnar bodies 32 is, for example, 2 μm or less, and may be 1 μm or less.

The structure in which at least one of the outer diameter and the height of the columnar body 32 and the interval between two adjacent columnar bodies 32 changes continuously or stepwise according to the distance to the focal point includes not only a structure in which at least one of the outer diameter and the height of the columnar body 32 and the interval between two adjacent columnar bodies 32 monotonously changes as illustrated in FIGS. 14 and 15 but also a periodic structure in which such a structure forms a unit (hereinafter, also referred to as structural unit), and the structural unit is periodically disposed in the radial direction with respect to the central axis C4 of the phase grating. In other words, the metalens 3 according to the second embodiment may have a periodic structure in which a structural unit in which at least one of the height, the maximum width, and the pitch of each of the plurality of columnar bodies 32 changes continuously or stepwise is periodically disposed in the radial direction.

In the optical system 102, the shortest distance between the first end face 1A1 of the core 1A and the metalens 3 is preferably as short as possible. The shortest distance between the Si waveguide 2A and the metalens 3 is preferably a value as close to the focal length f as possible, and more preferably equal to the focal length f.

The optical path length between the first end face 1A1 of the core 1A and the second end face 2A1 of the Si waveguide 2A in the optical system 102 may be shorter as compared with an optical system in which the core 1A and the Si waveguide 2A are optically connected by a polymer waveguide or a convex lens.

Also in the optical system 102, the propagation direction of light is not limited. Light may be propagated from the core 1A having a relatively large light spot size to the Si waveguide 2A having a relatively small light spot size via the metalens 3, or may be propagated from the Si waveguide 2A to the core 1A via the metalens 3 in the opposite direction.

The method for forming the metalens 3 of the optical system 102 is not particularly limited either. The plurality of columnar bodies 32 of the metalens 3 may be formed by patterning a dielectric film after the dielectric film is formed on the third surface 4A of the substrate 4. For example, a photoresist may be applied onto the dielectric film formed on the third surface 4A of the substrate 4, the photoresist may be exposed and developed through a mask on which a pattern is drawn, and then the dielectric film may be etched using the photoresist as a mask. The plurality of columnar bodies 32 may be formed by, for example, a screen printing method or the like.

In the optical system 102, the optical path length between the core 1A and the Si waveguide 2A limited by the thickness and the focal depth of the metalens 3 may be shorter than the optical path length of the polymer waveguide that may optically connect the core 1A and the Si waveguide 2A or the sum of the thickness and the focal depth of the convex lens that may optically connect the core 1A and the Si waveguide 2A. In addition, in the optical system 102, the degree of freedom in designing the focal position is high as compared with an optical system including a convex lens, and the focal depth and the light propagation direction can be easily changed.

The metalens 3 of the optical system 102 may be disposed on the third surface 4A or the fourth surface 4B of the substrate 4.

As described above, the structure in which at least one of the outer diameter and the height of the columnar body 32 and the interval between two adjacent columnar bodies 32 changes continuously or stepwise according to the distance to the focal point includes not only a structure in which at least one of the outer diameter and the height of the columnar body 32 and the interval between two adjacent columnar bodies 32 monotonously changes as illustrated in FIGS. 14 and 15 but also a periodic structure in which such a structure forms a structural unit, and the structural unit is periodically disposed in the radial direction with respect to the central axis C4 of the phase grating. Each structural unit includes the first region R1 and the second region R2.

In the periodic structure in which the structural unit illustrated in FIG. 14 is periodically disposed in the radial direction with respect to the central axis C4 of the phase grating, the radial width of each structural unit may be set such that the phase change amount at each columnar body 32 is within the range of 0 to 2π in each structural unit. In addition, in each structural unit illustrated in FIG. 14, it is preferable that the radial width of each structural unit is set such that the phase change amount of the light propagated through the columnar body 32 farthest from the central axis C4 of the phase grating with respect to the phase of the light propagated through the columnar body 32 closest to the central axis C4 of the phase grating is 2π. In this case, the radial width of each structural unit required for the phase change amount to be 2π in each structural unit becomes narrower as the distance from the central axis C4 increases. For example, among the plurality of structural units included in the periodic structure, the radial width of the first structural unit positioned closest to the central axis C4 of the phase grating is set to be wider than the radial width of the second structural unit positioned second closest to the central axis C4 of the phase grating. The radial width of each structural unit required for the phase change amount to be 2π in each structural unit changes according to the diameter of the metalens 3. In the metalens 3 having a diameter of 10 μm, the radial width of the first structural unit required for the phase change amount to be 2π in the first structural unit is preferably 1.00 μm or more and 3.50 μm or less. In the metalens 3 having a diameter of 20 μm, the radial width of the first structural unit required for the phase change amount to be 2π in the first structural unit is preferably 2.00 μm or more and 5.00 μm or less. In the metalens 3 having a diameter of 40 μm, the radial width of the first structural unit required for the phase change amount to be 2π in the first structural unit is preferably 3.00 μm or more and 7.00 μm or less.

The focal length f (unit: nm) of the metalens 3 including the phase grating, the light condensing angle θ₂ of the metalens 3, and the radius R (unit: nm) of the metalens 3 satisfy the following Relational Expression (2).

$$\begin{matrix}[ Mathematical Formula 3 ] & \\ f = \frac{R}{tan {θ}_{2}} & ( 2 )\end{matrix}$$

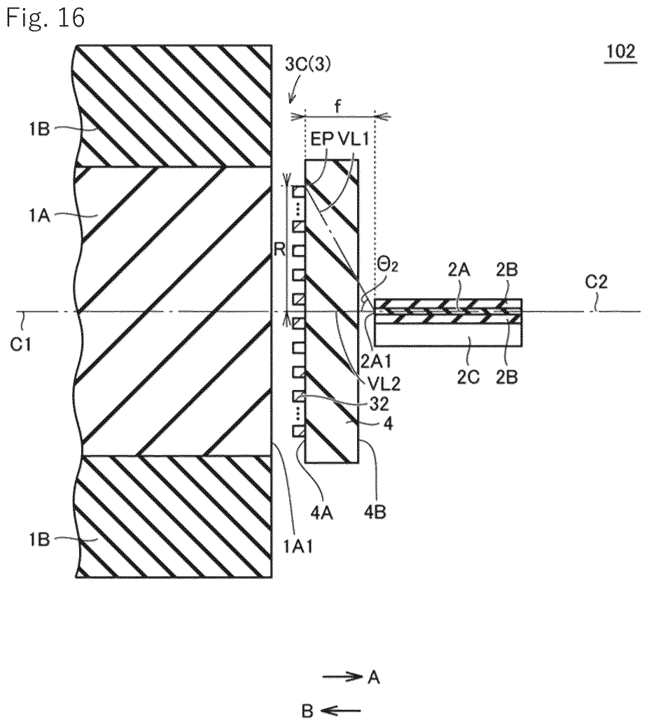

FIG. 16 illustrates the focal length f, the radius R, and the light condensing angle θ₂ of the metalens 3 including the metasurface 3C. The light condensing angle θ₂ illustrated in FIG. 16 is an angle formed by the first virtual straight line VL1 with respect to the second virtual straight line VL2. The first virtual straight line VL1 indicates the course of the light propagated through the columnar body 32 positioned outermost in the radial direction with respect to the central axis C4 among the plurality of columnar bodies 32. The first virtual straight line VL1 is a virtual straight line connecting the outermost end of the columnar body 32 positioned outermost in the radial direction on the third surface 4A side of the substrate 4 and the intersection of the central axis C2 of the Si waveguide 2A and the second end face 2A1. The second virtual straight line VL2 is a virtual straight line connecting an intersection between the central axis C3 of the metasurface 3C and the third surface 4A of the substrate 4 and an intersection between the central axis C2 of the Si waveguide 2A and the second end face 2A1. When the central axis C4 and the central axis C2 are disposed on the same straight line, the second virtual straight line VL2 is disposed on the same straight line.

The light condensing angle θ₂ of the metalens 3 including the metasurface 3C is, for example, 20° or more and 70° or less, and preferably 30° or more and 60° or less. Preferably, the length of the second virtual straight line VL2 is equal to the focal length f. When the light condensing angle θ₂ is 30° or more and 60° or less, the numerical aperture NA of the metalens 3 becomes smaller and the focal depth becomes deeper as compared with the case where the light condensing angle θ₂ is 70°. Thus, it is easy to adjust the position of the metalens 3 with respect to the Si waveguide 2A in the optical axis direction. The numerical aperture NA of the metalens 3 is calculated by multiplying the sine (Sin θ₂) of the light condensing angle θ₂ of the metalens 3 by the refractive index n of the medium present between the metalens 3 and the Si waveguide 2A.

In the metalens 3 of the optical system 102, the numerical aperture NA is preferably 0.5 or more, and more preferably 0.7 or more. The Si waveguide 2A is characterized in that the numerical aperture (spread of light) is large because the relative refractive index difference between Si constituting the core and SiO₂ constituting the cladding is large. To enhance the coupling efficiency between the metalens 3 and the Si waveguide 2A, the numerical aperture NA of the metalens 3 is preferably as large as the numerical aperture of the Si waveguide 2A.

### <Modification of Metalens>

Hereinafter, a modification of the metalens 3 of the optical system 102 will be described.

In the optical system 102, the material constituting the plurality of columnar bodies 32 may be metal. The phase grating of the metalens 3 may include a plurality of MIM waveguides instead of the plurality of dielectric waveguides.

### Third Embodiment

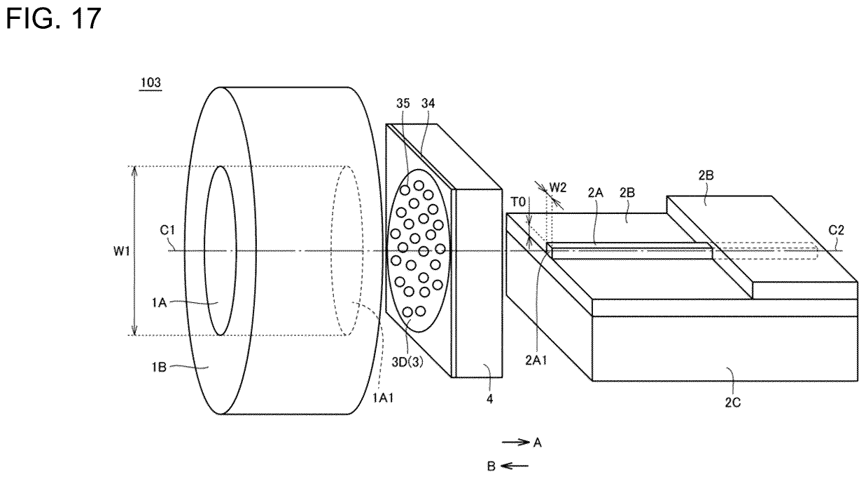

An optical system 103 according to a third embodiment will be described with reference to FIG. 17. The optical system 103 according to the third embodiment has a configuration basically similar to that of the optical system 102 according to the second embodiment and exhibits a similar effect, but is different from the optical system 102 in that the metalens 3 includes a resonance-side phase grating instead of a waveguide type phase grating. Hereinafter, the differences of the optical system 103 from the optical system 102 will be mainly described.

As illustrated in FIG. 17, the metalens 3 includes a metasurface 3D having a plurality of spherical bodies 35 (protrusions) disposed on the third surface 4A at an interval between each other and the filling portion 33 filling the space between the plurality of spherical bodies 35. The material constituting the plurality of spherical bodies 35 is, for example, a dielectric. The material constituting the filling portion 33 is, for example, air. The filling portion 33 may be formed of a dielectric film. The surfaces of the plurality of spherical bodies 35 may be in contact with the dielectric film. The plurality of spherical bodies 35 may be embedded in the filled portion 33.

Each of the plurality of spherical bodies 35 is provided so as to perform Mie resonance with light having the target wavelength. The phase of the light incident on each of the plurality of spherical bodies 35 changes in a process in which the light is scattered by resonance. As the outer diameter D of the spherical body 35 is larger, the frequency (resonance frequency) of the light resonated with the spherical body 35 is lower, and the wavelength (resonance wavelength) of the light resonated with each spherical body 35 is longer. As long as the wavelength of light incident on each spherical body 35 is not too long with respect to the wavelength (resonance wavelength) of light resonated with each spherical body 35, as the wavelength (resonance wavelength) of light resonated with each spherical body 35 is longer than the wavelength of light incident on each spherical body 35, the phase change amount of light scattered by each spherical body 35 increases. In this case, the phase change amount of light scattered by each spherical body 35 increases as the outer diameter D of the spherical body 35 increases.

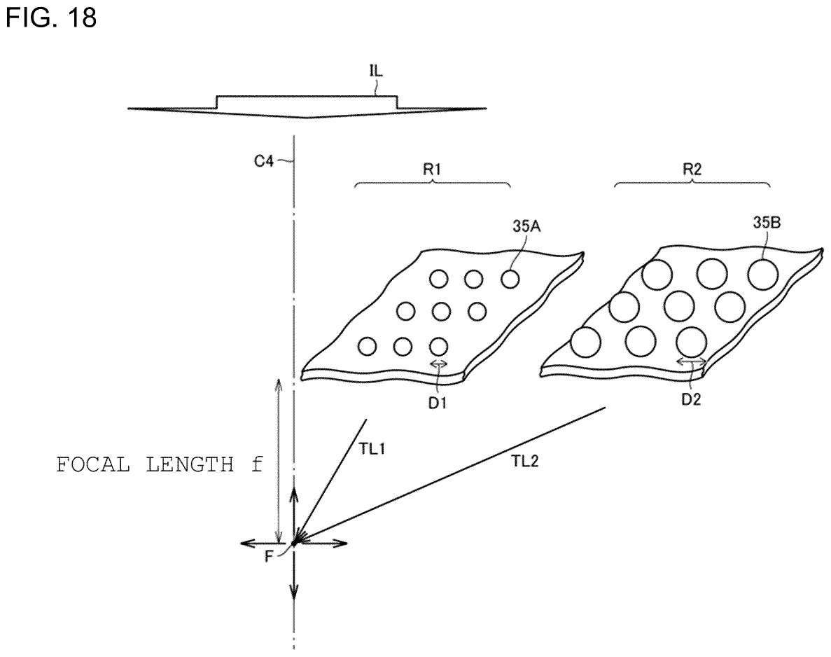

The position of the focal point F (see FIG. 18) of the metalens 3 changes according to the spatial distribution of the phase of the light scattered by each spherical body 35. Thus, the phase change amount of the light scattered by each spherical body 35 may be freely set according to the position where the focal point F of the metalens 3 is to be disposed.

In plan view, the outer diameter of the spherical body 35 changes continuously or stepwise according to the distance to the focal point. Preferably, in plan view, the outer diameter of each of the plurality of spherical bodies 35 is provided so as to increase as the distance from the focal point F of the metalens 3 increases.

As illustrated in FIG. 18, the metalens 3 includes a first region R1 in which the plurality of spherical bodies 35 are disposed such that the phase change amount becomes relatively small, and a second region R2 in which the plurality of spherical bodies 35 are disposed such that the phase change amount becomes relatively large. In plan view, the first region R1 is a region closer to the focal point F than the second region R2. The outer diameter D2 of the spherical body 35 in a second group formed in the second region R2 is larger than the outer diameter D1 of the spherical body 35A in a first group formed in the first region R1. With this configuration, the phase change amount of light TL2 scattered by each of the spherical bodies 35B in the second group is larger than the phase change amount of light TL1 scattered by each of the spherical bodies 35A in the first group.

When the focal point F is disposed on the same straight line as the central axis C4 of the phase grating of the metalens 3, the outer diameter of the spherical body 35 may change continuously or stepwise according to the distance to the central axis C4 in plan view.

The outer diameter of each of the plurality of spherical bodies 35 is equal to or less than the target wavelength. The outer diameter of each of the plurality of spherical bodies 35 is, for example, several 10 nm or more and 1 μm or less.

In the optical system 103, the shortest distance between the first end face 1A1 of the core 1A and the metalens 3 is preferably as short as possible. The shortest distance between the Si waveguide 2A and the metalens 3 is preferably a value as close to the focal length f as possible, and more preferably equal to the focal length f.

The optical path length between the first end face 1A1 of the core 1A and the second end face 2A1 of the Si waveguide 2A in the optical system 103 may be short as compared with an optical system in which the core 1A and the Si waveguide 2A are optically connected by a polymer waveguide or a convex lens.

Also in the optical system 103, the propagation direction of light is not limited. Light may be propagated from the core 1A having a relatively large light spot size to the Si waveguide 2A having a relatively small light spot size via the metalens 3, or may be propagated from the Si waveguide 2A to the core 1A via the metalens 3 in the opposite direction.

The method for forming the metalens 3 of the optical system 103 is not particularly limited either. The plurality of spherical bodies 35 of the metalens 3 may be formed by, for example, a known method for producing nanoparticles.

In the optical system 103, the optical path length between the core 1A and the Si waveguide 2A limited by the thickness and the focal depth of the metalens 3 may be shorter than the optical path length of the polymer waveguide that may optically connect the core 1A and the Si waveguide 2A or the sum of the thickness and the focal depth of the convex lens that may optically connect the core 1A and the Si waveguide 2A. In addition, in the optical system 103, the degree of freedom in designing the focal position is high as compared with an optical system including a convex lens, and the focal depth and the light propagation direction can be easily changed.

The metalens 3 of the optical system 103 may be disposed on the third surface 4A or the fourth surface 4B of the substrate 4.

### <Modification of Metalens>

In the optical system 103, the material constituting the plurality of spherical bodies 35 may be metal. In this case, each of the plurality of spherical bodies 35 is provided so as to perform plasmon resonance with light having the target wavelength. The phase of the light incident on each of the plurality of spherical body 35 changes in the process of being scattered by resonance of the light with each spherical body 35. Also in the spherical body 35 made of metal, similarly to the spherical body 35 made of a dielectric, the larger the outer diameter D of the spherical body 35 is, the larger the phase change amount of light is. That is, the principle that the phase of the light scattered by the spherical body 35 changes differs depending on the material constituting the spherical body 35, but the tendency that the phase change amount of the light increases as the outer diameter D of the spherical body 35 increases is the same regardless of the material constituting the spherical body 35.

The shape of the metalens 3 of the optical system 103 may also be changed in the same manner as the metalens 3 of the optical system 102. The structure in which at least one of the outer diameter and the height of the spherical body 35 and the interval between two adjacent spherical bodies 35 changes continuously or stepwise according to the distance to the focal point includes not only a structure in which at least one of the outer diameter and the height of the spherical body 35 and the interval between two adjacent spherical bodies 35 monotonously changes but also a periodic structure in which such a structure forms a structural unit, and the structural unit is periodically disposed in the radial direction with respect to the central axis C4 of the phase grating.

### Fourth Embodiment

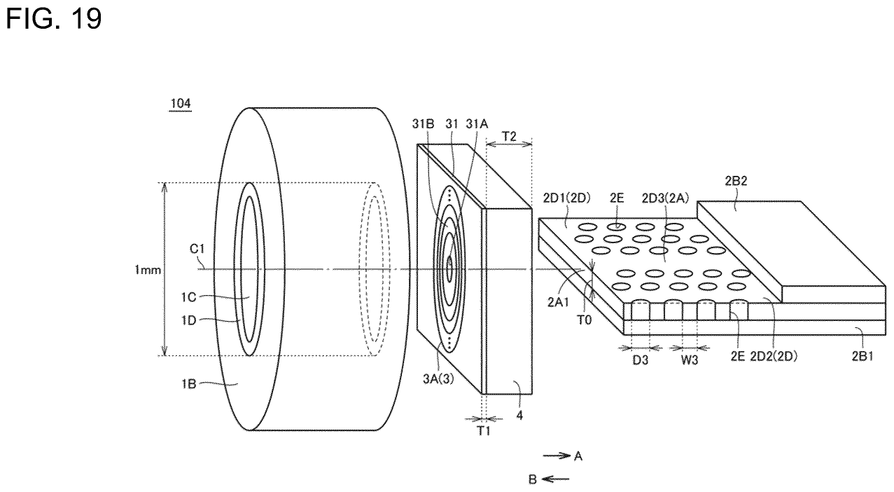

An optical system 104 according to a fourth embodiment will be described with reference to FIG. 19. The optical system 104 according to the fourth embodiment has a configuration basically similar to that of the optical systems 101 to 103 according to any one of the first to third embodiments, and exhibits a similar effect, but is different from the optical systems 101 to 103 in that the second waveguide is not a thin wire waveguide but a photonic crystal waveguide. Hereinafter, the differences of the optical system 104 from the optical systems 101 to 103 will be mainly described.

The photonics device 2 includes a crystal slab 2D, the first cladding layer 2B1, and the second cladding layer 2B2. The second waveguide is a part of the crystal slab 2D. The crystal slab 2D includes two regions 2D1 and 2D2 in which a plurality of through holes 2E are formed, and a region 2D3 sandwiched between the two regions 2D1 and 2D2 and in which a plurality of through holes 2E are not formed. The material constituting the crystal slab 2D contains, for example, at least one selected from the group consisting of polytetrafluoroethylene (PTFE), polyimide, and cyclic olefin polymer (COP).

The opening shape of the plurality of through holes 2E is, for example, a circular shape. The center of each of the plurality of through holes 2E is disposed to form a lattice point of a regular hexagonal lattice. The hole diameter of each of the plurality of through holes 2E and the interval between two adjacent through holes 2E are provided such that light having the target wavelength does not propagate through the region 2D1 or the region 2D2. In a different point of view, the hole diameter of each of the plurality of through holes 2E and the interval between two adjacent through holes 2E are provided such that the region 2D3 where the through hole 2E is not formed forms a photonic crystal waveguide.

The first cladding layer 2B1 and the second cladding layer 2B2 are disposed so as to sandwich the crystal slab 2D. The refractive index of the material constituting each of the first cladding layer 2B1 and the second cladding layer 2B2 is lower than the refractive index of the material constituting the crystal slab 2D. The material constituting each of the first cladding layer 2B1 and the second cladding layer 2B2 contains, for example, SiO₂. One or both of the first cladding layer 2B1 and the second cladding layer 2B2 may be an air layer.

The optical system 104 is provided to propagate, for example, a terahertz wave. The target wavelength of the optical system 104 is, for example, 30 μm or more and 3 mm or less. The optical fiber 1 is a metal hollow optical fiber, and it may include a hollow portion 1C, a metal layer 1D, and the cladding 1B. The hollow portion 1C is filled with air. The metal layer 1D has an inner peripheral surface facing the hollow portion 1C and an outer peripheral surface in contact with the inner peripheral surface of the cladding 1B. The material constituting the metal layer 1D is not particularly limited, but includes, for example, silver (Ag). The thickness of the metal layer 1D is, for example, several nm or more and several 100 nm or less. The outer diameter of the metal layer 1D is, for example, 1 mm or less.

Also in the optical system 104, the propagation direction of light is not limited. Light may be propagated from the core 1A having a relatively large light spot size to the Si waveguide 2A having a relatively small light spot size via the metalens 3, or may be propagated from the Si waveguide 2A to the core 1A via the metalens 3 in the opposite direction.

As described above, the optical system 104 is suitable for an optical system for propagating a terahertz wave. In this case, the material constituting the crystal slab 2D contains, as described above, at least one selected from the group consisting of polytetrafluoroethylene (PTFE), polyimide, and cyclic olefin polymer (COP). On the other hand, the light propagated by the optical system 104 is not limited to the terahertz wave. The target wavelength of the optical system 104 may be shorter than the terahertz wave, and in this case, the material constituting the crystal slab 2D may be Si.

### Fifth Embodiment

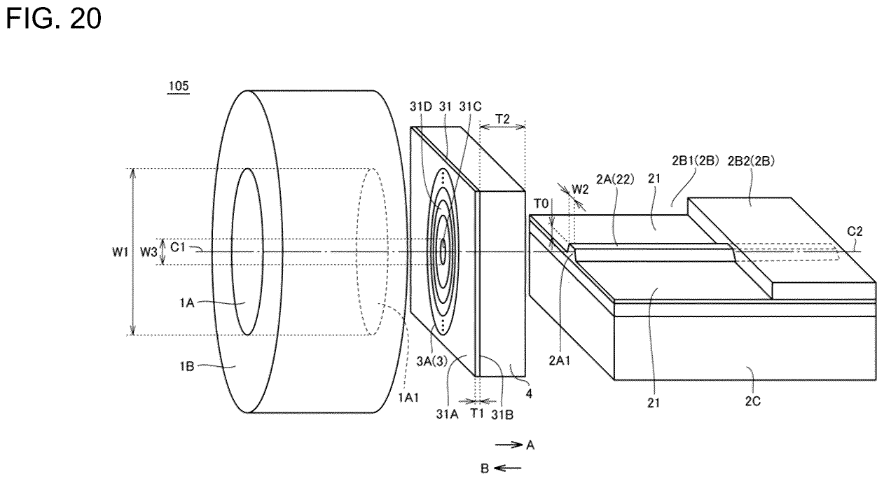

An optical system 105 according to a fifth embodiment will be described with reference to FIG. 20. The optical system 105 according to the fifth embodiment has a configuration basically similar to that of the optical systems 101 to 103 according to any one of the first to third embodiments, and exhibits a similar effect, but is different from the optical systems 101 to 103 in that the Si waveguide 2A is not a thin wire waveguide but a rib type waveguide. Hereinafter, the differences of the optical system 105 from the optical systems 101 to 103 will be mainly described.

The Si waveguide 2A includes a slab portion 21 having a relatively wide width in a direction orthogonal to each of a stacking direction of the Si substrate 2C, the first cladding layer 2B1, the Si waveguide 2A, and the second cladding layer 2B2, and an extending direction of the Si waveguide 2A, and a ridge portion 22 protruding from the slab portion 21 to the side opposite to the first cladding layer 2B1 and having a relatively narrow width in the direction. In the optical system 105, the ridge portion 22 and a portion of the slab portion 21 positioned in the vicinity of the ridge portion 22 constitute the Si waveguide 2A.

Also in the optical system 105, the propagation direction of light is not limited. Light may be propagated from the core 1A having a relatively large light spot size to the Si waveguide 2A having a relatively small light spot size via the metalens 3, or may be propagated from the Si waveguide 2A to the core 1A via the metalens 3 in the opposite direction.

In the optical system 105, the photonics device 2 may have a PIN structure. Specifically, when viewed from the stacking direction of the slab portion 21 and the ridge portion 22, the slab portion 21 may include a p-type impurity region formed on one side with respect to the ridge portion 22 and an n-type impurity region formed on the other side with respect to the ridge portion 22. In this case, the photonics device 2 may further include an electrode electrically connected to the p-type impurity region and an electrode electrically connected to the n-type impurity region.

### Sixth Embodiment

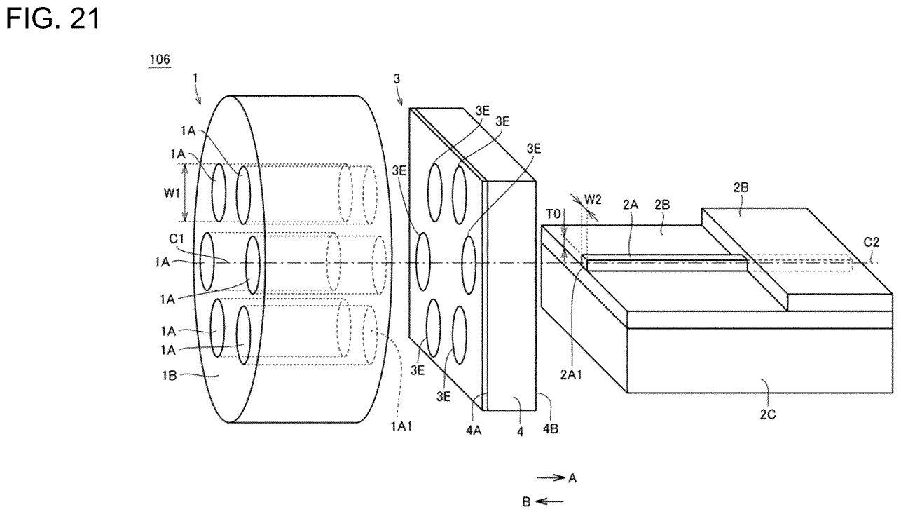

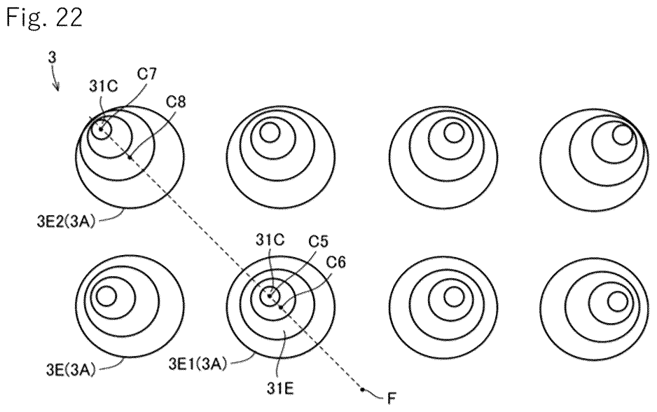

An optical system 106 according to a sixth embodiment will be described with reference to FIG. 21. The optical system 106 according to the sixth embodiment has a configuration basically similar to that of the optical systems 101 to 105 according to any one of the first to fifth embodiments and exhibits a similar effect, but is different from the optical systems 101 to 105 in that the optical fiber 1 includes a plurality of cores 1A and the metalens 3 includes a plurality of metasurfaces 3E. Hereinafter, the differences of the optical system 106 from the optical systems 101 to 105 will be mainly described.

The optical fiber 1 is a multicore fiber. Each of the plurality of cores 1A is, for example, a single-mode fiber. In plan view, the plurality of cores 1A is disposed at an interval between each other. The cladding 1B separates the plurality of cores 1A from each other. The alignment of the plurality of cores 1A in plan view is not limited. The plurality of cores 1A illustrated in FIG. 21 is rotationally symmetric with respect to the central axis C1 of the optical fiber 1. In plan view, the plurality of cores 1A may be disposed such that the central axis of each core 1A forms a lattice point of a square lattice, a triangular lattice, or a hexagonal lattice. The plurality of cores 1A does not have to be rotationally symmetric with respect to the central axis C1 of the optical fiber 1.

Each of the plurality of cores 1A has, for example, properties equivalent to each other. The plurality of cores 1A may have different properties. For example, when the optical fiber 1 includes a central core disposed on the central axis C1 of the optical fiber 1 in plan view and a plurality of peripheral cores disposed around the central core and having a rotationally symmetric relationship with each other, the core diameter of the central core may be larger than the core diameter of each of the peripheral cores.

The dimension (core diameter W1) of the first end face 1A1 of each core 1A is larger than each of the width W2 and the thickness T0 of the second end face 2A1 of the second waveguide. Each core diameter W1 is 1 μm or more and 20 μm or less, and preferably 5 μm or more and 10 μm or less.

The metalens 3 condenses the light emitted from each of the plurality of cores 1A on one second waveguide (for example, the Si waveguide 2A). The light emitted from one core 1A is incident on each of the plurality of metasurfaces 3E. All the light emitted from the plurality of metasurfaces 3E is incident on the Si waveguide 2A. That is, each metasurface 3E optically connects one core 1A and the Si waveguide 2A.

Each of the plurality of metasurfaces 3E is any one of the metasurface 3A, the metasurface 3B, the metasurface 3C, and the metasurface 3D described above. Each of the plurality of metasurfaces 3E is provided such that the light emitted from each metasurface 3E is focused on the second end face 2A1 of the Si waveguide 2A. Specifically, the propagation direction of the light emitted from each metasurface 3E is set such that the light emitted from each metasurface 3E is focused on the second end face 2A1 of the Si waveguide 2A.

The alignment of the plurality of metasurfaces 3E in plan view is set according to the alignment of the plurality of cores 1A. The plurality of metasurfaces 3E illustrated in FIG. 21 is rotationally symmetric with respect to the central axis C1 of the optical fiber 1. When the rotational symmetry axes of the plurality of metasurfaces 3E are set as the central axis of the metalens 3, the central axis of the metalens 3 is disposed on the same straight line as the central axis C1 of the optical fiber 1.

In plan view, the plurality of metasurfaces 3E may be disposed such that the center of each metasurface 3E forms a lattice point of a square lattice, a triangular lattice, or a hexagonal lattice. The plurality of metasurfaces 3E do not have to be rotationally symmetric with respect to the central axis C1 of the optical fiber 1.

The plurality of electromagnetic wave scatterers of each metasurface 3E are aligned, for example, in a direction orthogonal to the propagation direction of light between the first end face and the second end face. When each metasurface 3E is the metasurface 3A, the plurality of uneven structures 31D of each metasurface 3A are aligned, for example, in a direction orthogonal to the central axis C1 of the core 1A and the central axis C2 of the Si waveguide 2A. The central axis of the through hole 31C of each metasurface 3A is, for example, parallel to the central axis C1 of the core 1A and the central axis C2 of the Si waveguide 2A. When each metasurface 3E is the metasurface 3C or the metasurface 3D, the plurality of columnar bodies 32 or the plurality of spherical bodies 35 are aligned, for example, in a direction orthogonal to the central axis C1 of the core 1A and the central axis C2 of the Si waveguide 2A.

FIG. 22 illustrates a configuration example in which each of the plurality of metasurfaces 3E is the metasurface 3A having a bullseye structure, and the center of each metasurface 3E is disposed to form a lattice point of a square lattice in plan view. The center of each metasurface 3E (3A) means the center of the outline of each metasurface 3E. The plurality of metasurfaces 3E (3A) are formed in, for example, one conductor layer 31, and are supported by one substrate 4.

Each of the plurality of metasurfaces 3E may be formed in different conductor layers 31. Each of the plurality of metasurfaces 3E may be supported on different substrates 4.

Also in the metalens 3 illustrated in FIG. 22, the propagation direction of the light emitted from each metasurface 3E (3A) toward the Si waveguide 2A is set such that the light emitted from each metasurface 3E (3A) is focused on the second end face 2A1 of the Si waveguide 2A.

As illustrated in FIG. 22, in plan view, the central axis of the through hole 31C of each metasurface 3E (3A) is disposed on the side opposite to the focal point F with respect to the center of the metasurface 3E (3A). In plan view, the central axis of the through hole 31C of each metasurface 3E (3A) may be disposed on an imaginary straight line connecting the center of the metasurface 3E (3A) and the focal point F. In plan view, a central axis C5 of the through hole 31C of one metasurface 3E1 may be disposed on an imaginary straight line connecting the center C6 of the metasurface 3E1 and the focal point F. In plan view, the central axis C7 of the through hole 31C of the metasurface 3E2 farther from the focal point F than the metasurface 3E1 may be disposed on an imaginary straight line connecting a center C8 of a metasurface 3E2 and the focal point F. The virtual straight line of the metasurface 3E2 may be disposed on the same straight line as the virtual straight line of the metasurface 3E1.

As illustrated in FIG. 22, in plan view, the distance between the center of each metasurface 3E (3A) and the central axis of the through hole 31C of the metasurface 3E (3A) may be shorter as the distance between the center of the metasurface 3E and the focal point F of the metalens 3 is shorter. The distance between the central axis C5 of the through hole 31C of the metasurface 3E1 and the center C6 of the metasurface 3E1 may be shorter than the distance between the central axis C7 of the through hole 31C of the metasurface 3E2 and the center C8 of the metasurface 3E2.

Also in the optical system 106, the propagation direction of light is not limited. Light may be propagated from each of the plurality of cores 1A having a relatively large light spot size to the Si waveguide 2A having a relatively small light spot size via each metasurface 3E of the metalens 3, or may be propagated from the Si waveguide 2A to each of the plurality of cores 1A via each metasurface 3E of the metalens 3 in the opposite direction.

### <Modification of Optical System>

In the optical system 106, the plurality of electromagnetic wave scatterers of each metasurface 3E may be arrayed in a direction inclined at an obtuse angle or an acute angle with respect to the propagation direction of light between the first end face and the second end face. When each metasurface 3E is the metasurface 3A, the plurality of uneven structures 31D of each metasurface 3A may be aligned in a direction inclined at an obtuse angle or an acute angle with respect to the central axis C1 of the core 1A and the central axis C2 of the Si waveguide 2A, for example. When each metasurface 3E is the metasurface 3C or the metasurface 3D, the plurality of columnar bodies 32 or the plurality of spherical bodies 35 may be aligned in a direction forming an obtuse angle or an acute angle with the central axis C1 of the core 1A and the central axis C2 of the Si waveguide 2A. In such a case, when the metasurfaces 3E are supported on different substrates 4, the distances between each metasurfaces 3E and the first end face 1A1 of the corresponding core 1A may be set as short as possible and equal to each other.

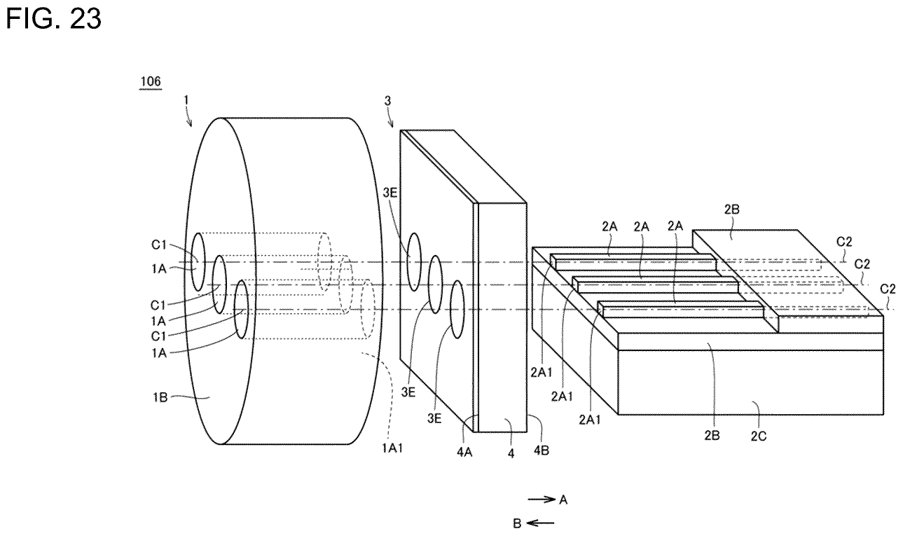

In the optical system 106, the photonics device 2 may include a plurality of second waveguides. The number of second waveguides may be equal to or less than the number of first waveguides. As illustrated in FIG. 23, the number of second waveguides may be equal to the number of first waveguides. The light emitted from each of the plurality of cores 1A may enter different Si waveguides 2A via different metasurfaces 3E. That is, the optical system 106 may include a plurality of sets of optical systems (optical system in which one first waveguide and one second waveguide are optically connected via one metalens (metasurface 3E)) implemented in the optical systems 101 to 105. In the optical system 106, the plurality of optical systems may have configurations equivalent to each other or different from each other. The alignment of the plurality of optical systems is not particularly limited, but they may be disposed side by side in a horizontal direction, for example.

### Seventh Embodiment

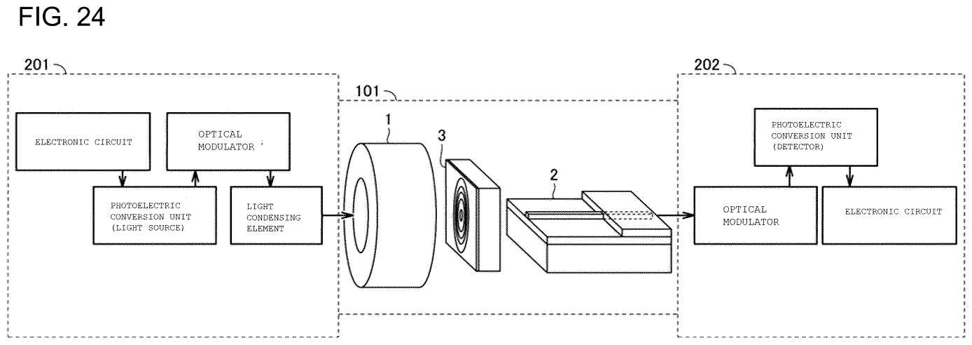

An optical system 107 according to a seventh embodiment will be described with reference to FIG. 24. The optical system 107 according to the seventh embodiment is different from the optical systems 101 to 106 in that it further includes an information output unit 201 and an information input unit 202 in addition to the optical systems 101 to 106 of any one of the first to sixth embodiments. Hereinafter, the differences of the optical system 107 from the optical systems 101 to 106 will be mainly described.

The information output unit 201 includes, for example, an electronic circuit, a photoelectric conversion unit (that is, light source) that outputs an optical signal according to an electric signal flowing through the electronic circuit, an optical modulator that performs phase modulation of the optical signal output from the photoelectric conversion unit, and a light condensing element that condenses light phase-modulated by the optical modulator. The information input unit 202 includes, for example, an optical modulator, a photoelectric conversion unit, and an electronic circuit.

In the optical system 107, as illustrated in FIG. 24, the core 1A of any of the optical systems 101 to 106 may be optically connected to the information output unit 201 that outputs an optical signal, and the Si waveguide 2A may be optically connected to the information input unit 202 to which the optical signal is input. In this case, the core 1A is optically connected to the light condensing element of the information output unit 201. The light condensed by the light condensing element is incident on the core 1A. The Si waveguide 2A is optically connected to the optical modulator of the information input unit 202. The light emitted from the Si waveguide 2A is phase-modulated by the optical modulator of the information input unit 202, then converted into an electronic signal by the photoelectric conversion unit, and transmitted to the electronic circuit.

That is, in the optical system 107 illustrated in FIG. 24, a signal sequentially travels through the electronic circuit, the photoelectric conversion unit, the optical modulator, and the light condensing element of the information output unit 201, the core 1A of any of the optical systems 101 to 106, the metalens 3, the Si waveguide 2A, and the optical modulator, the photoelectric conversion unit, and the electronic circuit of the information input unit 202.

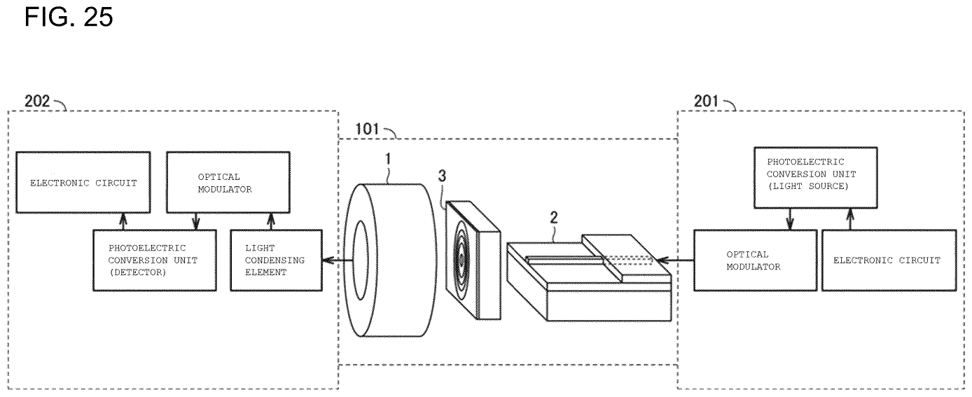

On the other hand, in the optical system 107, as illustrated in FIG. 25, the Si waveguide 2A of any of the optical systems 101 to 106 may be optically connected to the information output unit 201, and the core 1A may be optically connected to the information input unit 202. In this case, the Si waveguide 2A is optically connected to the optical modulator of the information output unit 201. The core 1A is optically connected to the light condensing element of the information input unit 202.

That is, in the optical system 107 illustrated in FIG. 25, a signal sequentially travels through the electronic circuit, the photoelectric conversion unit, and the optical modulator of the information output unit 201, the Si waveguide 2A of any of the optical systems 101 to 106, the metalens 3, the core 1A, and the light condensing element, the optical modulator, the photoelectric conversion unit, and the electronic circuit of the information input unit 202.

The information output unit 201 may include at least a light source that outputs an optical signal. The information output unit 201 may include an optical lens, or may include the metalens 3 of the optical systems 101 to 106 as the light condensing element.

### Experimental Example

Hereinafter, the evaluation results of the optical properties of each of the above-described metalenses will be described with reference to the drawings.

<Light Condensing Performance of Meta Lens Having Metasurface of Bullseye Structure with Different Interval P>

### (1) Experimental Examples 1 to 8

As Experimental Examples 1 to 7, metalenses having a metasurface of a bullseye structure having the planar structure illustrated in FIG. 3 and the sectional structure illustrated in FIG. 11 were produced. Specifically, an electron beam resist (NEB-22) was applied onto a glass substrate by spin coating, and exposed to the electron beam resist using an electron beam lithography apparatus (ELS-F125HS, ELIONIX) to form a plurality of resist patterns concentrically. The interval between the plurality of resist patterns was set to 1550 nm, 1310 nm, 1000 nm, or 900 nm. A conductive film made of silver was formed on the glass substrate by a sputtering method using a magnetron sputtering coater (Q-150TES, Quorum Technologies). Thereafter, the conductive film on the glass substrate was immersed in a dimethylacetamide solution, and the excess conductive film on the resist pattern was lifted off. In this manner, the metalens 3 of Experimental Examples 1 to 7 having the sectional structure illustrated in FIG. 11, in which the intervals P of the plurality of uneven structures 31D are different from each other according to the interval of the resist pattern, was produced. Further, Experimental Example 8 including only a glass substrate was prepared.

In Experimental Examples 1 to 7, the ratio (W5/P) of the width (W5) of each of the plurality of annular grooves 31E to the interval P of each of the plurality of uneven structures 31D was set to 50%. In each of Experimental Examples 1 to 7, the hole diameter (W3) of the through hole 31C was equal to the width (W5).
(2) Method for Evaluating Light Condensing Performance

Each of Experimental Examples 1 to 8 was irradiated with light (linearly polarized light) having wavelengths of 1550 nm and 1310 nm such that the light became collimated light. In Experimental Examples 1 to 7, irradiation was performed such that light was condensed in the through hole 31C. The light emitted from the metalens was imaged on the image sensor using an objective lens, and from the obtained image, the spreading angle X of the linearly polarized light on the polarization plane and the spreading angle Y of the linearly polarized light on the plane orthogonal to the polarization plane were evaluated.

The light condensing performance of each sample was evaluated based on the following criteria with respect to the spreading angles X and Y.
S: less than 4.00°
A: 4.00° or more and less than 5.50°
B: 5.50° or more and less than 7.50°
C: 7.50° or more and less than 9.00°
D: 9.00° or more
(3) Evaluation Result

The evaluation results are shown in Table 1.

TABLE 1

| | | | | Light condensing | |
|---|---|---|---|---|---|
| | Interval | Incident | | property | |
| | P | wavelength | Ratio | Spreading | Spreading |
| | (nm) | λ (nm) | P/λ | angle X | angle Y |
| Experimental | 1550 | 1310 | 1.18 | A | A |
| Example 1 | | | | | |
| Experimental | 1310 | 1310 | 1.00 | A | A |
| Example 2 | | | | | |
| Experimental | 1310 | 1550 | 0.85 | A | S |
| Example 3 | | | | | |
| Experimental | 1000 | 1310 | 0.76 | A | S |
| Example 4 | | | | | |
| Experimental | 900 | 1310 | 0.69 | B | A |
| Example 5 | | | | | |
| Experimental | 1000 | 1550 | 0.65 | B | B |
| Example 6 | | | | | |
| Experimental | 900 | 1550 | 0.58 | C | B |
| Example 7 | | | | | |
| Experimental | — | 1550 | — | D | D |
| Example 8 | | | | | |

As shown in Table 1, in Experimental Examples 1 to 7, it was confirmed that the spreading angles X and Y were smaller than those in Experimental Example 8, and high light condensing performance was exhibited. In Experimental Examples 1 to 6 in which the ratio P/λ was higher than 0.58, it was confirmed that as compared with Experimental Example 7 in which the ratio P/λ was 0.58, the spreading angles X and Y were small, and the light condensing performance was high. In Experimental Examples 1 to 5 in which the ratio P/λ was higher than 0.65, it was confirmed that as compared with Experimental Example 6 in which the ratio P/λ was 0.65, the spreading angle Y was small, and the light condensing performance was high. In Experimental Examples 1 to 4 in which the ratio P/λ was higher than 0.69, it was confirmed that as compared with Experimental Example 5 in which the ratio P/λ was 0.69, the spreading angles X and Y were small, and the light condensing performance was high. In Experimental Examples 3 to 7 in which the ratio P/λ was higher than 0.58 and lower than 1.00, it was confirmed that the spreading angle Y tended to be smaller than the spreading angle X. In Experimental Examples 1 to 2 in which the ratio P/λ was higher than 1.00, it was confirmed that the spreading angle X tended to be as small as the spreading angle Y. The spreading angle Y was the smallest in Experimental Examples 3 and 4 in which the ratio P/λ was larger than 0.69 and smaller than 1.00.

<Light Condensing Performance of Metalens Having Metasurface of Bullseye Structure with Different Ratio W5/P>

### (4) Experimental Examples 9 to 13 and Method for Evaluating Light Condensing Performance in Experimental Examples 9 to 13

As Experimental Examples 9 to 13, metalenses having a metasurface of a bullseye structure having the planar structure illustrated in FIG. 3 and the sectional structure illustrated in FIG. 11 were designed using electromagnetic calculation software MEEP. In Experimental Examples 9 to 13, the interval P was common at 1550 nm, and only the width W5 of each of the plurality of annular grooves 31E was different from each other. That is, in Experimental Examples 9 to 13, the ratios W5/P were different from each other.

As the light condensing performance of each experimental example, the transmission intensity, the reflection intensity, and the electric field intensity around the structure when a plane wave having a wavelength of 1550 nm was incident on each experimental example were simulated using the above calculation software, and the ratio of the calculated transmission intensity to the reflection intensity of each experimental example was evaluated based on the following criteria.
S: 0.40 or more
A: 0.20 or more and less than 0.40
B: 0.04 or more and less than 0.20
(5) Evaluation Result

The evaluation results are shown in Table 2.

TABLE 2

| | Experimental | Experimental | Experimental | Experimental | Experimental |
|---|---|---|---|---|---|
| | Example 9 | Example 10 | Example 11 | Example 12 | Example 13 |
| Ratio W5/P | 87.5% | 75.0% | 50.0% | 43.0% | 34.0% |
| Ratio | S | S | A | B | B |
| transmission | | | | | |
| intensity/ | | | | | |
| reflection | | | | | |
| intensity | | | | | |

As shown in Table 2, in Experimental Examples 9 to 13 in which the ratio W5/P was 34.0% or more, the ratio of the transmission intensity to the reflection intensity was 0.04 or more. It was confirmed that the ratio of the transmission intensity to the reflection intensity of Experimental Examples 9 to 11 in which the ratio W5/P is higher than 43.0% was 0.20 or more, which is higher than that of Experimental Examples 12 and 13 in which the ratio W5/P is 43.0% or less. That is, it was confirmed that the light condensing performance of Experimental Examples 9 to 11 in which the ratio W5/P is higher than 43.0% was higher than that of Experimental Examples 12 and 13 in which the ratio W5/P is 43.0% or less. It was confirmed that the ratio of the transmission intensity to the reflection intensity of Experimental Examples 9 and 10 in which the ratio W5/P is higher than 50.0% was 0.40 or more, which is higher than that of Experimental Example 11 in which the ratio W5/P is 50.0%. That is, it was confirmed that the light condensing performance of Experimental Examples 9 and 10 in which the ratio W5/P is higher than 50.0% was higher than that of Experimental Example 11 in which the ratio W5/P is 50.0%.

<Light Condensing Performance of Metalens Having Metasurface of Bullseye Structure with Different Sectional Structure>

### (6) Experimental Examples 14 and 15 and Method for Evaluating Light Condensing Performance in Experimental Examples 14 and 15

As Experimental Examples 14 and 15, metalenses having a metasurface of a bullseye structure having the planar structure illustrated in FIG. 3 and the sectional structure illustrated in FIG. 2 or the sectional structure illustrated in FIG. 11 were designed using electromagnetic calculation software MEEP. The sectional structure of the metasurface of Experimental Example 14 was the structure illustrated in FIG. 11, and the sectional structure of the metasurface of Experimental Example 15 was the structure illustrated in FIG. 2. The other configurations of Experimental Examples 14 and 15 were equivalent to each other. In Experimental Examples 14 and 15, the interval P was 1550 nm, and the ratio W5/P was 100%.

As the light condensing performance of each experimental example, the transmission spectrum and the reflection spectrum formed when a plane wave having a wavelength in a range of 1300 nm to 1900 nm was incident on each experimental example were simulated using the electromagnetic calculation software, and the transmission properties and the reflection properties were evaluated based on the following criteria based on the reflection intensity and the transmission intensity of each experimental example calculated by the simulation. Each strength was a normalized strength (optional unit a.u.).
Evaluation criteria A of transmission properties: Peak with intensity of 0.04 or more is present
Evaluation criteria S of transmission properties: Peak with intensity of 0.10 or more is present
Evaluation criteria A of reflection properties: Intensity is less than 0.04 over entire wavelength range
Evaluation criteria S of reflection properties: Intensity is less than 0.01 over entire wavelength range
(7) Evaluation Result

The evaluation results are shown in Table 3.

TABLE 3

| | Transmission | Reflection |
|---|---|---|
| Experimental | S | A |
| Example 14 | | |
| Experimental | A | S |
| Example 15 | | |

As shown in Table 3, in Experimental Examples 14 and 15, since the transmission intensity was sufficiently high, and the reflection intensity was sufficiently low, it was confirmed that excellent light condensing performance was exhibited.

<Light Condensing Performance of Metalens Having Metasurface of Bullseye Structure in Which Centers of Plurality of Uneven Structures are Disposed so as Not to Overlap Center of Through Hole>

### (8) Experimental Examples 16 to 21 and Method for Evaluating Light Condensing Performance in Experimental Examples 16 to 21

As Experimental Examples 16 to 21, metalenses having a metasurface of a bullseye structure having the planar structure illustrated in FIG. 9 and the sectional structure illustrated in FIG. 11 were designed using electromagnetic calculation software MEEP. For each of Experimental Examples 16 to 21, the first interval PA was common at 1550 nm, the ratio W5A/PA was common at 50%, and only the unit shift amount S was changed stepwise.

As the light condensing performance of each experimental example, the emission angle of light emitted from each experimental example when a plane wave having a wavelength of 1550 nm was incident on each experimental example was calculated using the electromagnetic calculation software.

### (9) Evaluation Result

The evaluation results are shown in Table 4. In Table 4, the unit shift amount S (unit: nm) is described as a ratio using the first interval PA.

TABLE 4

| | Experimental | Experimental | Experimental | Experimental | Experimental | Experimental |
|---|---|---|---|---|---|---|
| | Example 16 | Example 17 | Example 18 | Example 19 | Example 20 | Example 21 |
| Unit shift | PA/16 | PA/12 | PA/8 | PA/6 | PA/5 | PA/4 |
| amount S | | | | | | |
| (nm) | | | | | | |
| Light | 3 | 7 | 16 | 20 | 30 | 40 |
| emission | | | | | | |
| angle θ₁ | | | | | | |
| (°) | | | | | | |

As shown in Table 4, it was confirmed that the emission angle of light increases as the unit shift amount S increases. In Experimental Example 16 in which the unit shift amount S was PA/16 nm, the emission angle was 3°. In Experimental Example 18 in which the unit shift amount S was PA/8 nm, the emission angle was 16°. In Experimental Example 18 in which the unit shift amount S was PA/4 nm, the emission angle was 40°. It was confirmed that the emission angle of the light emitted from the metalens illustrated in FIG. 9 can be appropriately set according to the unit shift amount S.

In Experimental Examples 17 to 21, it was confirmed that the interval P (unit: nm) and the distance S (unit: nm) satisfy the following Relational Expression (1) when the emission angle θ₁ is 5° or more.

### <Light Condensing Property of Metalens Including Phase Grating Having Periodic Structure>

### (10) Experimental Examples 22 to 24 and Method for Evaluating Light Condensing Performance in Experimental Examples 22 to 24

As Experimental Examples 22 to 24, metalenses having different diameters from each other, the metalenses including a phase grating and including a periodic structure in which structural units illustrated in FIG. 11 are periodically disposed in a radial direction with respect to a central axis, were designed using electromagnetic calculation software MEEP. The diameter of the metalens of Experimental Example 22 was 10 μm, the diameter of the metalens of Experimental Example 23 was 20 μm, and the diameter of the metalens of Experimental Example 24 was 40 μm. In Experimental Examples 22 to 24, the refractive index of each columnar body was 3.5, and the numerical aperture NA was 0.7. The diameter of the metalens was set within a range of 10 μm to 40 μm that can be assumed as the core diameter of the optical fiber 1.

As the light condensing performance of each experimental example, the spatial distribution of the phase of light propagated through each of the plurality of columnar bodies included in the metalens when a plane wave having a wavelength of 1550 nm was incident on each experimental example was simulated using the electromagnetic calculation software. The focal length of each experimental example obtained by the simulation was evaluated based on the following criteria.
Evaluation criteria A of focal length: Focal length is smaller than lens diameter
Evaluation criteria S of focal length: Focal length is larger than lens diameter

In the simulation, the following Relational Expression (3) was used. Relational Expression (3) is a relational expression between the phase difference given to light having a target wavelength A at a distance r from the central axis by each metalens including the phase grating and the focal length f of each metalens. Using Relational Expression (3), when the target wavelength A was 1550 nm, the focal length f was calculated by substituting the diameter R of each metalens of Experimental Examples 22 to 24 into the distance r.

$$\begin{matrix}[ Mathematical Formula 4 ] & \\ ϕ ( r ) = \frac{2 π}{λ} ( \sqrt{( {r}^{2} + {f}^{2} )} - f ) & ( 3 )\end{matrix}$$

### (11) Evaluation Result

The evaluation results are shown in Table 5.

TABLE 5

| | | Experimental | Experimental | Experimental | Focal |
|---|---|---|---|---|---|
| | | Example 22 | Example 23 | Example 24 | length |
| Light | 20 | 3.71 | 5.22 | 7.36 | B |
| condensing | 30 | 2.96 | 4.16 | 5.84 | A |
| angle θ₂ (°) | 40 | 2.47 | 3.46 | 4.84 | A |
| | 45 | 2.27 | 3.16 | 4.44 | A |
| | 50 | 2.09 | 2.9 | 4.08 | A |
| | 60 | 1.75 | 2.42 | 3.4 | A |
| | 70 | 1.42 | 1.94 | 2.72 | A |

It was confirmed that the focal length f can be sufficiently shortened from the viewpoint of downsizing the optical system when the diameter of the metalens was 10 μm and the light condensing angle θ₂ was 30° or more. It was confirmed that the focal length f can be sufficiently shortened from the viewpoint of downsizing the optical system when the diameter of the metalens was 20 μm, even though the light condensing angle θ₂ was 20° or more. On the other hand, it was confirmed that when the light condensing angle θ₂ was 70°, it was difficult to adjust the position in the optical axis direction when an optical system was formed.

### DESCRIPTION OF REFERENCE SIGNS

1 . . . optical fiber
1A1 . . . first end face
1A . . . core
1B, 2B . . . cladding
1C . . . hollow portion
1D . . . metal layer
2 . . . photonics device
2A1 . . . second end face
2A . . . waveguide
2B1 . . . first cladding layer
2B2 . . . second cladding layer
2C . . . Si substrate
2D . . . crystal slab
2E . . . through hole
21 . . . slab portion
22 . . . ridge portion
3 . . . metalens
3A, 3B, 3C, 3D, 3E, 3E1, 3E2 . . . metasurface
31C . . . through hole
31 . . . conductor layer
31A . . . first surface
31B . . . second surface
31D, 31G . . . uneven structure
31E, 31H . . . annular groove
31F, 31I . . . protrusion
32, 32A, 32B . . . columnar body
33 . . . filling portion
34 . . . base material
35, 35A, 35B . . . spherical body
4 . . . substrate
4A . . . third surface
4B . . . fourth surface
101, 102, 103, 104, 105, 106, 107 . . . optical system
201 . . . information output unit
202 . . . information input unit

1. An optical system comprising:
a first waveguide;
a second waveguide having a light spot size different from a light spot size of the first waveguide; and
a metalens optically connecting a first end face of the first waveguide and a second end face of the second waveguide,
wherein the metalens includes a first surface facing the first waveguide and a second surface facing a side opposite to the first surface,
the metalens is formed with a through hole penetrating between the first surface and the second surface,
the through hole has a hole diameter smaller than a target wavelength,
the metalens is made of a conductor,
at least the first surface of the metalens is formed with a plurality of uneven structures including the first surface and a plurality of annular grooves recessed with respect to the first surface, and
the plurality of uneven structures are annularly formed surrounding the through hole in plan view.

2. The optical system according to claim 1, wherein a ratio (P/λ) of an interval P (unit: nm) of each of the plurality of uneven structures to the target wavelength λ (unit: nm) is 30% or more and 140% or less.

3. The optical system according to claim 2, wherein a ratio (W5/P) formed by a width W5 (unit: nm) of each of the plurality of annular grooves to the interval P of each of the plurality of uneven structures in a radial direction with respect to a central axis of the through hole is 10% or more and 95% or less.

4. The optical system according to claim 2, wherein a center of each of the plurality of uneven structures overlaps a center of the through hole in plan view.

5. The optical system according to claim 2, wherein a center of each of the plurality of uneven structures do not overlap a center of the through hole in plan view.

6. The optical system according to claim 5, wherein
the center of each of the plurality of uneven structures is arranged on a same straight line at equal distances from each other,
a central axis of the through hole and a central axis of the second waveguide form a first angle θ₁, and
the first angle θ₁ is 3° or more and 600 or less.

7. The optical system according to claim 6, wherein when the first angle θ₁ is 5° or more, the interval P and the distance S (unit: nm) satisfy Relational Expression (1) shown below:
$$\begin{matrix}[ Mathematical Formula 1 ] & \\ \frac{P}{( 0.036 {θ}_{1} - \frac{0.1123}{{θ}_{1}} + 0.0671 )} \leq S \leq \frac{P}{( 0.066 {θ}_{1} - \frac{0.0605}{{θ}_{1}} + 0.0671 )} & ( 1 )\end{matrix}$$

8. The optical system according to claim 1,
the optical system further comprising a substrate including a third surface that is transparent to light having the target wavelength and is in contact with the second surface of the metalens,
wherein each of the plurality of annular grooves penetrates between the first surface and the second surface of the metalens and is formed to expose a part of the third surface.

9. An optical system comprising:
a first waveguide;
a second waveguide having a light spot size different from a light spot size of the first waveguide;
a metalens optically connecting a first end face of the first waveguide and a second end face of the second waveguide; and
a substrate having a third surface that is transparent to light having a target wavelength and intersects with a propagation direction of the light,
wherein the metalens is a phase grating that is disposed on the third surface and gives a phase difference to the light having the target wavelength,
the metalens includes a plurality of protrusions disposed on the third surface at an interval between each other, and
each of the plurality of protrusions includes a first group of protrusions disposed at an interval between each other on a first region of the third surface and a second group of protrusions disposed at an interval between each other on a second region of the third surface, and at least one of a height, a maximum width, and a pitch of each of the first group of protrusions is different from at least one of a height, a maximum width, and a pitch of each of the second group of protrusions.

10. The optical system according to claim 9, wherein the metalens has a periodic structure in which structural units are periodically disposed in a radial direction with respect to a central axis of the metalens, each of the structural units including the first group of protrusions and the second group of protrusions, in which at least one of a height, a maximum width, and a pitch of each of the plurality of protrusions changes continuously or stepwise.

11. The optical system according to claim 10, wherein among the plurality of structural units included in the periodic structure of the metalens, a radial width of a first structural unit at a position closest to the central axis is wider than a radial width of a second structural unit at a position second closest to the central axis.

12. The optical system according to claim 11, wherein the radial width of the first structural unit is 1.00 μm or more and 7.00 μm or less.

13. The optical system according to claim 9, wherein
each of the plurality of protrusions is a columnar body or a spherical body, and
each of the plurality of protrusions has a maximum width shorter than the target wavelength.

14. The optical system according to claim 9, wherein
a light condensing angle formed by a first virtual straight line with respect to a second virtual straight line is 200 or more and 70° or less,
the first virtual straight line connecting:
an outermost end portion positioned at the third surface side of a protrusion among the plurality of protrusions, the protrusion being positioned outermost in the radial direction with respect to the central axis of the metalens; and
an intersection between a central axis of the second waveguide and the second end face,
the second virtual straight line connecting:
an intersection between the central axis of the metalens and the third surface; and
an intersection between the central axis of the second waveguide and the second end face.

15. The optical system according to claim 1, wherein
the first waveguide is at least one core of an optical fiber,
the second waveguide is a fine wire waveguide, a rib type waveguide, or a photonic crystal waveguide, and
the metalens is disposed between the first waveguide and the second waveguide.

16. The optical system according to claim 15, wherein a ratio of an area of the first end face to an area of the second end face is 10 or more.

17. The optical system according to claim 15, wherein
the first waveguide includes a plurality of cores discretely disposed, and
the metalens optically connects each of the plurality of cores and the second waveguide.

18. The optical system according to claim 17, wherein the metalens is provided such that light emitted from each of the plurality of cores is focused on a same straight line as a central axis of each of the first waveguide and the second waveguide.

19. The optical system according to claim 1, the optical system further comprising:
an information output unit optically connected to one of the first waveguide and the second waveguide; and
an information input unit optically connected to an other of the first waveguide and the second waveguide.

20. The optical system according to claim 19, wherein
the light spot size of the first waveguide is larger than the light spot size of the second waveguide,
the information output unit is optically connected to the first waveguide, and
the information input unit is optically connected to the second waveguide.
